(19) United States
(12) Patent Application Publication
(10) Pub. No.: US 2016/0277758 A1
(43) Pub. Date: Sep. 22, 2016

(54) IMAGE DECODING DEVICE AND IMAGE CODING DEVICE

(71) Applicant: SHARP KABUSHIKI KAISHA, Osaka-shi, Osaka (JP)

(72) Inventors: Tomohiro Ikai, Osaka-shi (JP); Yoshiya Yamamoto, Osaka-shi (JP)

(73) Assignee: SHARP KABUSHIKI KAISHA, Osaka-shi, Osaka (JP)

(21) Appl. No.: 15/029,389

(22) PCT Filed: Oct. 15, 2014
(86) PCT No.: PCT/JP2014/077454

§ 371 Date: Apr. 14, 2016

(30) Foreign Application Priority Data
Oct. 16, 2013 (JP) 2013-215160

(51) Int. Cl. H04N 19/57; H04N 19/91; H04N 19/44

(52) U.S. Cl. CPC H04N 19/57; H04N 19/44; H04N 19/91

(57) ABSTRACT

In view synthesis prediction, motion compensation has been performed in units of 4×4 blocks when the prediction block is AMP. Provided is an image decoding device (31) that generates and decodes a predicted image of a target prediction block, including a view synthesis predictor (3094, 3094′, 3094B, 3094B′) that generates a predicted image using view synthesis prediction. The view synthesis predictor partitions the prediction block into sub-blocks according to whether or not the height or the width of the prediction block is other than a multiple of 8, and derives a depth-derived disparity for each of the sub-blocks.

### TECHNICAL FIELD

The present invention relates to an image decoding device and an image coding device.

### BACKGROUND ART

Among multi-view image coding technologies, there is proposed parallax prediction coding that reduces the amount of information by predicting the parallax between images when coding images of multiple views, as well as a decoding method corresponding to the coding method. A vector expressing the parallax between view images is called a disparity vector. A disparity vector is a two-dimensional vector having a component in the horizontal direction (x component) and a component in the vertical direction (y direction), and is computed per block, a block being an area obtained by partitioning an image. Also, to acquire images of multiple views, it is typical to use cameras placed at each of the views. In multi-view coding, the respective view images are coded in multiple layers, with each view image being a respectively different layer. Coding methods for a moving image made up of multiple layers is generally called scalable coding or progressive coding. With scalable coding, a high coding efficiency is realized by making predictions between layers. The layer that acts as a base of reference without being predicted from other layers is called the base layer, while all other layers are called enhancement layers. Scalable coding for the case in which the layers are made up of view images is called view scalable coding. In this case, the base layer is also called the base view, while the enhancement layers are also called non-base views. Furthermore, scalable coding for the case in which the layers are made up of texture layers (image layers) and depth layers (depth map layers) in addition to being view-scalable is called three-dimensional scalable coding.

In addition, besides view scalable coding, scalable coding includes spatial scalable coding (processing a low-resolution picture as the base layer and high-resolution pictures as enhancement layers) and SNR scalable coding (processing a low-quality picture as the base layer and high-resolution pictures as enhancement layers), for example. In scalable coding, the picture in the base layer sometimes may be used as a reference picture in the coding of a picture in an enhancement layer, for example.

In addition, NPL 1 discloses a technology called view synthesis prediction that obtains more accurate predicted images by partitioning a prediction target block into small sub-blocks, and performing prediction using a disparity vector for each sub-block.

### CITATION LIST

### Non Patent Literature

NPL 1: 3D-HEVC Draft Text 1, JCT3V-E1001-v3, JCT-3V 5th Meeting: Vienna, KR, 2 Aug.-27 Jul., 2013

### SUMMARY OF INVENTION

### Technical Problem

In the view synthesis prediction of NPL 1, basically, pictures are processed by being partitioned into 8×4 and 4×8 sub-blocks (motion compensation blocks), which are the minimum PU sizes in HEVC. However, with NPL 1, in the coding unit (CU) partitioning mode called asymmetric motion partition (AMP), there is a problem in that selecting 12×16 and 16×12 blocks produces motion compensation blocks requiring processing in 4×4 units, which is smaller than the minimum PU size of HEVC.

### Solution to Problem

The present invention was devised to address the issue discussed above, and one mode of the present invention is an image decoding device that generates and decodes a predicted image of a target prediction block, including a view synthesis predictor that generates a disparity to use in view synthesis prediction. The view synthesis predictor sets a sub-block size according to whether or not the height or the width of the prediction block is a multiple of 8, and the view synthesis predictor uses the sub-block size to reference a depth and derive a depth-derived disparity.

In addition, another mode of the present invention is an image coding device that generates and decodes a predicted image of a target prediction block, including a view synthesis predictor that generates a disparity to use in view synthesis prediction. The view synthesis predictor sets a sub-block size according to whether or not the height or the width of a prediction block is a multiple of 8, and the view synthesis predictor uses the sub-block size to reference a depth and derive a depth-derived disparity.

### Advantageous Effects of Invention

According to the present invention, coding efficiency for view synthesis prediction is improved, and the amount of computation is reduced.

### BRIEF DESCRIPTION OF DRAWINGS

FIG. 1 is a schematic diagram illustrating a configuration of an image transmission system according to an embodiment of the present invention.

FIG. 2 is a diagram illustrating a hierarchical structure of data in a coded stream according to an embodiment.

FIG. 3 is a conceptual diagram illustrating an example of a reference picture list.

FIG. 4 is a conceptual diagram illustrating an example of a reference picture.

FIG. 5 is a schematic diagram illustrating a configuration of an image decoding device according to an embodiment.

FIG. 6 is a schematic diagram illustrating a configuration of an inter prediction parameter decoding section according to an embodiment.

FIG. 7 is a schematic diagram illustrating a configuration of a merge mode parameter derivation section according to an embodiment.

FIG. 8 is a schematic diagram illustrating a configuration of an AMVP prediction parameter derivation section according to an embodiment.

FIG. 9 is a conceptual diagram illustrating an example of a vector candidate.

FIG. 10 is a schematic diagram illustrating a configuration of an inter prediction parameter decoding control section according to an embodiment.

FIG. 11 is a schematic diagram illustrating a configuration of an inter-predicted image generation section according to an embodiment.

FIG. 12 is a diagram illustrating a process by a view synthesis section in a comparative example.

FIG. 13 is a diagram illustrating a process by a view synthesis predictor 3094 and a view synthesis predictor 3094′ according to an embodiment.

FIG. 14 is a schematic diagram illustrating a configuration of residual predictor according to an embodiment.

FIG. 15 is a conceptual diagram of residual prediction according to an embodiment (1 of 2).

FIG. 16 is a conceptual diagram of residual prediction according to an embodiment (2 of 2).

FIG. 17 is a schematic diagram illustrating a configuration of a view synthesis predictor according to an embodiment.

FIG. 18 is a diagram illustrating an example of a merge candidate list.

FIG. 19 is a diagram illustrating a process by a view synthesis predictor 3094 and a view synthesis predictor 3094B according to an embodiment.

FIG. 20 is a block diagram illustrating a configuration of an image coding device according to an embodiment.

FIG. 21 is a schematic diagram illustrating a configuration of an inter prediction parameter coding section according to an embodiment.

FIG. 22 is a diagram illustrating a process by a view synthesis predictor 3094′ according to an embodiment.

FIG. 23 is a diagram illustrating a process by a view synthesis predictor 3094B and a view synthesis predictor 3094B′ according to an embodiment.

FIG. 24 is a diagram illustrating a process by a view synthesis predictor 3094B′ according to an embodiment.

FIG. 25 is a diagram illustrating patterns of PU partition types, in which (a) to (h) illustrate the partition format for the case of the PU partition type being 2N×N, 2N×N, 2N×nU, 2N×nD, 2N×N, 2N×nU, 2N×nD, and N×N, respectively.

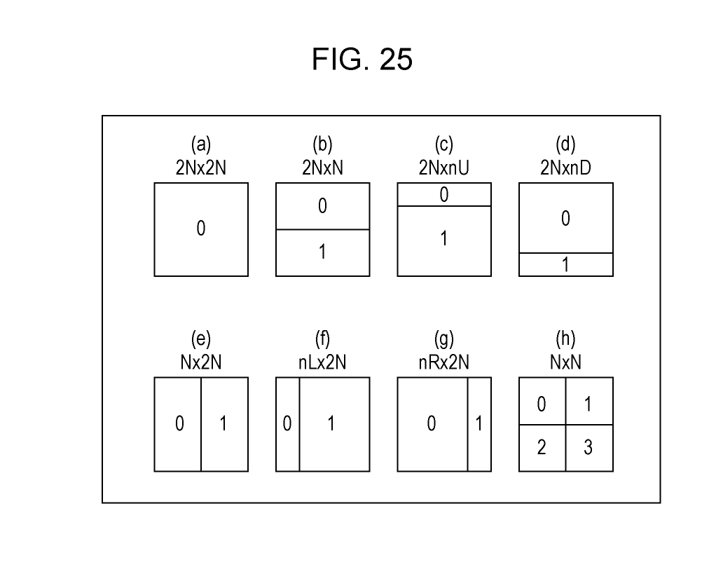

### DESCRIPTION OF EMBODIMENTS

### First Embodiment

Hereinafter, an embodiment of the present invention will be described with reference to the drawings.

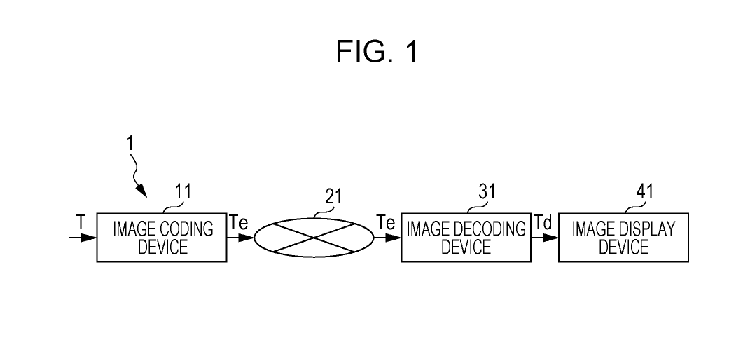

FIG. 1 is a schematic diagram illustrating a configuration of an image transmission system 1 according to the present embodiment.

The image transmission system 1 is a system that transmits a code encoding multiple layer images, and displays an image obtained by decoding the transmitted code. The image transmission system 1 includes an image coding device 11, a network 21, an image decoding device 31, and an image display device 41.

A signal T expressing multiple layer images (also called texture images) is input into the image coding device 11. A layer image is an image that is visually perceived or recorded at a certain resolution and a certain view. In the case of conducting view scalable coding that uses multiple layer images to code a three-dimensional image, each of the multiple layer images is called a view image. Herein, a view corresponds to the position of an image recording device or an observation point. For example, multiple view images are images recorded by respective image recording devices to the left and the right as seen facing the subject. The image coding device 11 codes each of these signals to generate a coded stream Te (coded data). The coded stream Te will be discussed in detail later. A view image is a two-dimensional (2D) image (planar image) observed at a certain viewpoint. A view image is expressed by luminance values or chroma signal values for individual pixels arranged in a 2D plane, for example. Hereinafter, a single view image or a signal expressing such a view image will be called a picture. In addition, in the case of conducting spatial scalable coding using multiple layer images, the multiple layer images are made up of a low-resolution base layer image and high-resolution enhancement layer images. In the case of conducting SNR scalable coding using multiple layer images, the multiple layer images are made up of a low-quality base layer image and high-quality enhancement layer images. Note that view scalable coding, spatial scalable coding, and SNR scalable coding may also be combined arbitrarily. The present embodiment treats with the coding and decoding of images including at least a base layer image and an image other than the base layer image (enhancement layer image) as the multiple layer images. Among the multiple layers, for two layers existing in a reference relationship (dependence relationship) with respect to image or coding parameters, the image being referenced will be called the first layer image, while the referencing image will be called the second layer image. For example, in the case of an enhancement layer (other than the base layer) image coded by referencing the base layer, the base layer image is treated as the first layer image, while the enhancement layer image is treated as the second layer image. Note that examples of enhancement layer images include images other than the base view, depth images, and the like.

A depth map (also called a depth image or a distance image) refers to an image signal made up of signal values (called depth values, depths, or the like) corresponding to the distances of a photographic subject or background included in the subject space from a viewpoint (such as an image recording device), being signal values (pixel values) for individual pixels arranged on a two-dimensional flat plane. The pixels constituting a depth map correspond to the pixels constituting a viewpoint image. Consequently, a depth map becomes a clue for expressing the subject space in three dimensions using view images, which are image signals acting as a reference and obtained by projecting the subject space onto a two-dimensional plane.

The network 21 transmits the coded stream Te generated by the image coding device 11 to the image decoding device 31. The network 21 is the Internet, a wide area network (WAN), a local area network (LAN), or some combination thereof. The network 21 is not strictly limited to a bidirectional communication network, and may also be a unidirectional or bidirectional communication network that transmits a broadcast wave such as a digital terrestrial broadcast or a satellite broadcast. Additionally, the network 21 may also be substituted with a storage medium having the coded stream Te recorded thereon, such as a Digital Versatile Disc (DVD) or a Blu-ray Disc (BD).

The image decoding device 31 decodes each coded stream Te transmitted by the network 21, and generates multiple decoded layer images Td (decoded view images Td) that have been decoded respectively.

The image display device 41 displays all or some of the multiple decoded layer images Td generated by the image decoding device 31. For example, in view scalable coding, a three-dimensional image (stereoscopic image) or a free viewpoint image is displayed in the case of all, while a two-dimensional image is displayed in the case of some. The image display device 41 is equipped with a display device such as a liquid crystal display or an organic electro-luminescence (EL) display. Additionally, in spatial scalable coding and SNR scalable coding, when the image decoding device 31 and the image display device 41 have high processing performance, enhancement layer images of high image quality are displayed, whereas when the image decoding device 31 and the image display device 41 only have a lower processing performance, the base layer image which does not require as much processing performance and display performance as the enhancement layers is displayed.

<Structure of Coded Stream Te>

Before describing the image coding device 11 and the image decoding device 31 according to the present embodiment in detail, the data structure of the coded stream Te generated by the image coding device 11 and decoded by the image decoding device 31 will be described.

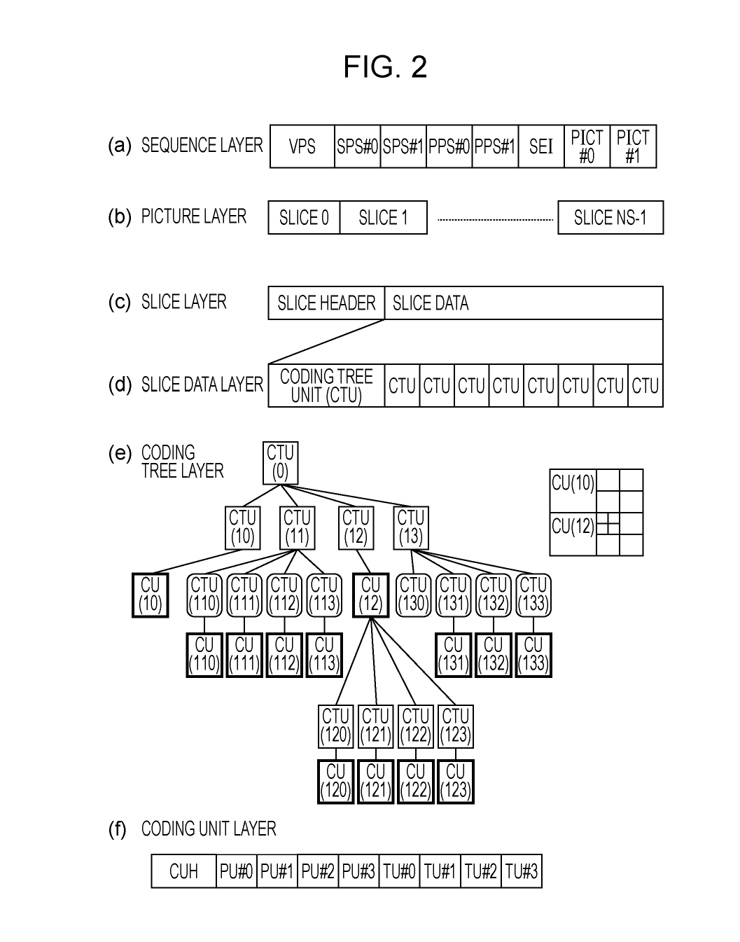

FIG. 2 is a diagram illustrating a hierarchical structure of data in the coded stream Te. As an example, the coded stream Te includes a sequence, as well as multiple pictures constituting the sequence. FIGS. 2(a) to 2(f) are diagrams illustrating a sequence layer that specifies a sequence SEQ, a picture layer that specifies a picture PICT, a slice layer that specifies a slice S, a slice data layer that specifies slice data, a coding tree layer that specifies a coding tree unit included in the slice data, and a coding unit layer that specifies a coding unit (CU) included in the coding tree, respectively.

(Sequence Layer)

In the sequence layer, there is specified a set of data that the image decoding device 31 references to decode a sequence SEQ being processed (hereinafter also called the target sequence). As illustrated in FIG. 2(a), the sequence SEQ includes a video parameter set, a sequence parameter set (SPS), a picture parameter set (PPS), a picture PICT, and supplemental enhancement information (SEI). Herein, the values indicated after # indicate a layer ID. In FIG. 2, an example is given in which coded data exists in #0 and #1, or in other words layer 0 and layer 1, but the types of layers and number of layers are not limited thereto.

The video parameter set VPS specifies, for a moving image made up of multiple layers, a set of coding parameters shared in common among multiple moving images and a set of coding parameters related to multiple layers and individual layers included in a moving image.

In the sequence parameter set SPS, there is specified a set of coding parameters that the image decoding device 31 references to decode a target sequence. For example, the width and height of a picture is specified.

In the picture parameter set PPS, there is specified a set of coding parameters that the image decoding device 31 references to decode each picture in the target sequence. For example, a nominal value of a quantization width used for picture decoding (pic_init_qp_minus26) and a flag indicating the application of weighted prediction (weighted_pred_flag) are included. Note that multiple PPSs may also exist. In this case, one of the multiple PPSs is selected from each picture in the target sequence.

(Picture Layer)

In the picture layer, there is defined a set of data that the image decoding device 31 references to decode a picture PICT being processed (hereinafter also called the target picture). As illustrated in FIG. 2(b), a picture PICT includes slices S0 to SNS−1 (where NS is the total number of slices included in the picture PICT).

Note that the subscripts of the sign may be omitted in cases where distinguishing each of the slices S0 to SNS−1 is unnecessary. The above similarly applies to other data given subscripts from among the data included in the coded stream Te described hereinafter.

(Slice Layer)

In the slice layer, there is defined a set of data that the image decoding device 31 references to decode a slice S being processed (hereinafter also called the target slice). As illustrated in FIG. 2(c), a slice S includes a slice header SH and slice data SDATA.

The slice header SH includes a coding parameter group that the image decoding device 31 references to decide a decoding method for the target slice. Slice type designation information (slice type) that designates a slice type is one example of a coding parameter included in the slice header SH.

Potential slice types that may be designated by the slice type designation information include (1) I slices that use only intra prediction for coding, (2) P slices that use unidirectional prediction or intra prediction for coding, and (3) B slices that use unidirectional prediction, bidirectional prediction, or intra prediction for coding.

Note that the slice header SH may also include a reference (pic_parameter_set_id) to a picture parameter set PPS included in the above sequence layer.

(Slice Data Layer)

In the slice data layer, there is specified a set of data that the image decoding device 31 references to decode slice data SDATA being processed. As illustrated in FIG. 2(d), the slice data SDATA includes a coding tree block (CTB). The CTB is a block of fixed size (for example, 64×64) constituting a slice, and is also called the largest coding unit (LCU).

(Coding Tree Layer)

As illustrated in FIG. 2(e), in the coding tree layer, there is specified a set of data that the image decoding device 31 references to decode a coding tree block being processed. The coding tree unit is recursively partitioned by quadtree subdivision. Nodes in a tree structure obtained by recursive quadtree subdivision are called a coding tree. Intermediate nodes of the quadtree are coding tree units (CTUs), and the coding tree block itself is also specified as the highest CTU. A CTU includes a partition flag (splif_flag). When splif_flag is 1, the relevant CTU is partitioned into four coding tree units CTU. When splif_flag is 0, the relevant coding tree unit CTU is partitioned into four coding units (CUs). The coding units CU are the end nodes of the coding tree layer, and the current layer is not partitioned any further. The coding units CU are the basic units of the coding process.

Also, when the size of the coding tree block CTB is 64×64 pixels, the coding units may take a size from among 64×64 pixels, 32×32 pixels, 16×16 pixels, and 8×8 pixels.

(Coding Unit Layer)

As illustrated in FIG. 2(f), in the coding unit layer, there is specified a set of data that the image decoding device 31 references to decode a coding unit being processed. Specifically, a coding unit is made up of a CU header CUH, a prediction tree, a transform tree, and a CU header CUF. In the CU header CUH, information such as whether the coding unit is a unit that uses intra prediction or a unit that uses inter prediction is specified. In addition, the CU header CUH includes a residual prediction weighting index iv_res_pred_weight_idx that indicates whether the coding unit is a unit that uses residual prediction, and an illumination compensation flag ic_flag that indicates whether the coding unit is a unit that uses illumination compensation prediction. A coding unit becomes the root of a prediction tree (PT) and a transform tree (TT). The CU header CUF is included between the prediction tree and the transform tree, or after the transform tree.

In the prediction tree, the coding unit is partitioned into one or multiple prediction blocks, and the position and size of each prediction block are specified. Stated differently, prediction blocks are one or multiple non-overlapping regions that constitute a coding unit. In addition, the prediction tree includes the one or more prediction blocks obtained by the above partitioning.

A prediction process is conducted on each prediction block. Hereinafter, these prediction blocks which are the units of prediction will also be referred to as prediction units (PUs).

Roughly speaking, there are two types of partitions in a prediction tree: one for the case of intra prediction, and one for the case of inter prediction. Intra prediction refers to prediction within the same picture, whereas inter prediction refers to a prediction process conducted across different pictures (for example, across display times or across layer images).

In the case of intra prediction, the partition method may be 2N×2N (the same size as the coding unit) or N×N.

Meanwhile, in the case of inter prediction, the partition method is coded by a partition mode part_mode in the coded data. Provided that the size of the target CU is 2N×2N, the PU partition type designated by the partition mode part_mode may be any of the following eight patterns. Namely, there are four symmetric splittings of 2N×2N pixels, 2N×N pixels, N×2N pixels, and N×N pixels, as well as four asymmetric motion partitions (AMPs) of 2N×nU pixels, 2N×nD pixels, nL×2N pixels, and nR×2N pixels. Note that N=2^{m} (where m is an arbitrary integer of 1 or greater). Hereinafter, a prediction block in which the PU partition type is an asymmetric motion partition will also be called an AMP block. Since the number of partitions is any of 1, 2, and 4, the number of PUs included in the CU is from one to four. These PUs are expressed as PU0, PU1, PU2, and PU3 in order.

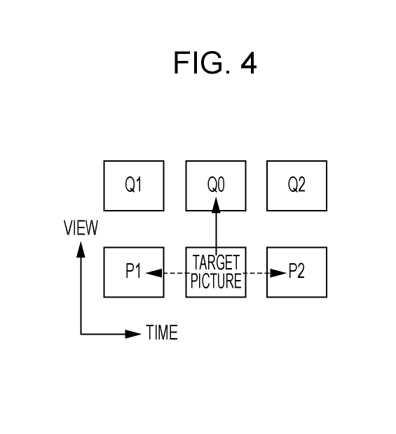

FIGS. 4(a) to 4(h) specifically illustrate the position of the PU partition boundary in the CU for each partition type.

FIG. 4(a) illustrates the 2N×2N PU partition type in which the CU is not partitioned. Also, FIGS. 4(b) and 4(e) illustrate the shape of the partition for the PU partition types 2N×N and N×2N, respectively. Also, FIG. 4(h) illustrates the shape of the partition for the PU partition type N×N.

In addition, FIGS. 4(c), 4(d), 4(f), and 4(g) illustrate the shape of the partition for the asymmetric motion partitions (AMPs) 2N×nU, 2N×nD, nL×2N, and nR×2N, respectively.

Also, in FIGS. 4(a) to 4(h), the numbers labeling respective regions represent identification numbers for the regions, and the regions are processed in order of identification number. In other words, the identification number represents the scan order of the regions.

In a prediction block in the case of inter prediction, seven of the above eight partition types, excluding only N×N (FIG. 4(h)), are defined.

In addition, the specific value of N is specified by the size of the CU to which the relevant PU belongs, while the specific values of nU, nD, nL, and nR are determined according to the value of N. For example, a 32×32 pixel CU may be partitioned into 32×32 pixel, 32×16 pixel, 16×32 pixel, 32×16 pixel, 32×8 pixel, 32×24 pixel, 8×32 pixel, and 24×32 pixel prediction blocks for inter prediction.

Meanwhile, in the transform tree, a coding unit is partitioned into one or multiple transform blocks, and the position and size of each transform block are specified. Stated differently, transform blocks are one or multiple non-overlapping regions that constitute a coding unit. In addition, the transform tree includes the one or more transform blocks obtained by the above partitioning.

Partitioning in the transform tree may be performed by laying out regions equal in size to the coding unit as transform blocks, or by recursive quadtree partitioning similar to the tree block partitioning discussed above.

A transform process is conducted on each transform block. Hereinafter, these transform blocks which are the units of transformation will also be referred to as transform units (TUs).

(Prediction Parameters)

A predicted image of a prediction unit is derived by prediction parameters associated with the prediction unit. The prediction parameters may be prediction parameters for intra prediction or prediction parameters for inter prediction. Hereinafter, prediction parameters for inter prediction (inter prediction parameters) will be described. Inter prediction parameters are made up of prediction list use flags predFlagL0 and predFlagL1, reference picture indices refIdxL0 and refIdxL1, and vectors mvL0 and mvL1. The prediction list utilization flags predFlagL0 and predFlagL1 are flags indicating whether or not reference picture lists called the L0 list and the L1 list are used, respectively. The corresponding reference picture list is used when the value of the flag is 1. Note that in this specification, the phrase “flag indicating whether or not XX” means that 1 is treated as the case in which XX is true and 0 as the case in which XX is false, while for logical NOT and AND operations or the like, 1 is treated as true and 0 as false (this applies similarly hereinafter). However, other values may also be used as the true value and the false value in actual devices and methods. The case of using two reference picture lists, or in other words the case of (predFlagL0, predFlagL1)=(1, 1) corresponds to bi-prediction, whereas the case of using one reference picture list, or in other words the case of (predFlagL0, predFlagL1)=(1, 0) or (predFlagL0, predFlagL1)=(0, 1) corresponds to uni-prediction. Note that information about the prediction list utilization flags may also be expressed by the inter prediction flag inter_pred_idc discussed later. Ordinarily, the prediction list utilization flags are used in the predicted image generator and the prediction parameter memory discussed later, while the inter prediction flag inter_pred_idc is used when decoding information about whether or not each reference picture list is used from coded data.

Elements for deriving the inter prediction parameters included in the coded data may be, for example, a partition mode part_mode, a merge flag merge_flag, a merge index merge_idx, an inter prediction flag inter_pred_idc, a reference picture index refId×LX, a prediction vector index mvp_LX_idx, and a difference vector mvdLX.

(Example of Reference Picture List)

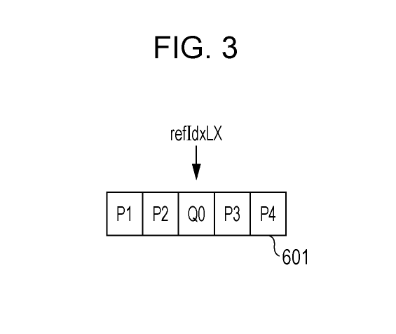

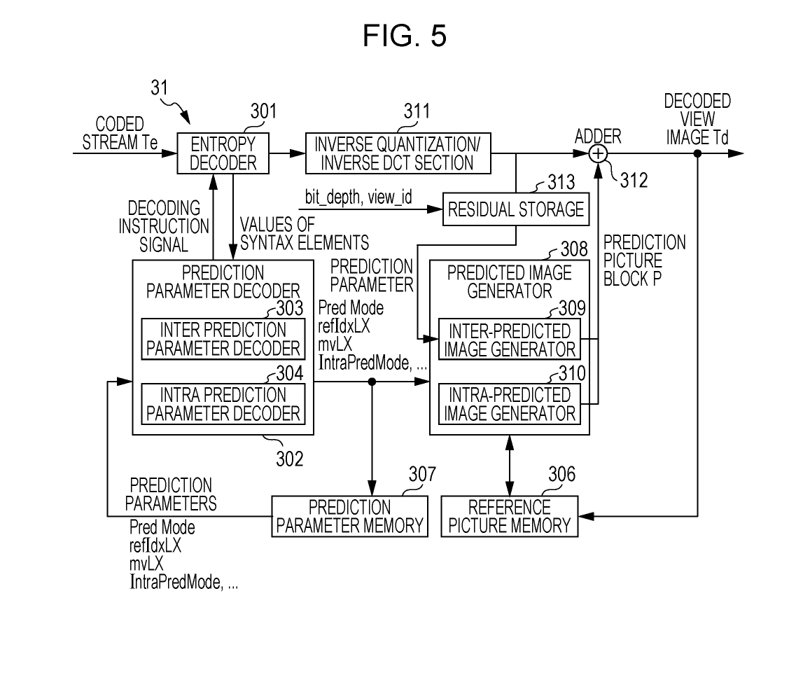

Next, an example of a reference picture list will be described. A reference picture list is a sequence made up of reference pictures stored in reference picture memory 306 (FIG. 5). FIG. 3 is a conceptual diagram illustrating an example of a reference picture list. In the reference picture list 601, the five rectangles arranged in a row from left to right indicate respective reference pictures. The signs P1, P2, Q0, P3, and P4 indicated in order from left to right are signs indicating the respective reference pictures. P, such as P1, indicates a view P, while Q of Q0 indicates a view Q that is different from the view P. The subscripts of P and Q indicate the picture order count POC. The downward arrow underneath refIdxLX indicates that the reference picture index refIdxLX is an index referencing the reference picture Q0 in the reference picture memory 306.

(Example of Reference Picture)

Next, an example of a reference picture used when deriving a vector will be described. FIG. 4 is a conceptual diagram illustrating an example of a reference picture. In FIG. 4, the horizontal axis represents display time, while the vertical axis represents view. The rectangles on two rows arranged vertically and three columns arranged horizontally (for a total of six) illustrated in FIG. 4 indicate respective pictures. From among the six rectangles, the rectangle on the bottom row and the second column from the left indicates the picture to be decoded (target picture), while the remaining five rectangles indicate respective reference pictures. The reference picture Q0 indicated by the arrow pointing upward from the target picture is a picture having the same display time as the target picture, but from a different view. In disparity prediction taking the target picture as a base, the reference picture Q0 is used. The reference picture P1 indicated by the arrow pointing to the left from the target picture is a picture from the same view as the target picture, but in the past. The reference picture P2 indicated by the arrow pointing to the right from the target picture is a picture from the same view as the target picture, but in the future. In motion prediction taking the target picture as a base, the reference picture P1 or P2 is used.

(Inter Prediction Flag and Prediction List Utilization Flags)

The inter prediction flag inter_pred_idc and the prediction list utilization flags predFlagL0 and predFlagL1 have a mutually transformable relationship using the expressions

inter_pred_idc=(predFlagL1<<1)+predFlagL0

predFlagL0=inter_pred_idc &1

predFlagL1=inter_pred_idc>>1

where >> is a right shift and << is a left shift. For this reason, as an inter prediction parameter, the prediction list utilization flags predFlagL0 and predFlagL1 may be used, or the inter prediction flag inter_pred_idc may be used. In addition, in the following, a determination using the prediction list utilization flags predFlagL0 and predFlagL1 may also be replaced by the inter prediction flag inter_pred_idc. Conversely, a determination using the inter prediction flag inter_pred_idc may also be replaced by the prediction list utilization flags predFlagL0 and predFlagL1.

(Merge Mode and AMVP Prediction)

Methods of decoding (or coding) prediction parameters include a merge mode and an adaptive motion vector prediction (AMVP) mode. The merge flag merge_flag is a flag for distinguishing between these modes. In both merge mode and AMVP mode, the prediction parameters of the target PU are derived by using the prediction parameters of already-processed blocks. The merge mode is a mode that uses already-derived prediction parameters as-is, without including the prediction list utilization flags predFlagLX (or the inter prediction flag inter_pred_idc), the reference picture index refIdxLX, and the vector mvLX in the coded data, whereas the AMVP mode is a mode that includes the inter prediction flag inter_pred_idc, the reference picture index refIdxLX, and the vector mvLX in the coded data. Note that the vector mvLX is coded as a prediction vector index mvp_LX_idx indicating a prediction vector, and a difference vector (mvdLX).

The inter prediction flag inter_pred_idc is data indicating the type and number of reference pictures, and takes a value from among Pred_L0, Pred_L1, and Pred_Bi. Pred_L0 and Pred_L1 indicate that the reference pictures stored in the reference picture lists called the L0 list and the L1 list are used, respectively, and also indicate that one reference picture is used (uni-prediction). Prediction using the L0 list and L1 list is called L0 prediction and L1 prediction, respectively. Pred_Bi indicates that two reference pictures are used (bi-prediction), and indicates that two reference pictures stored in the L0 list and the L1 list are used. The prediction vector index mvp_LX_idx is an index indicating a prediction vector, and the reference picture index refldxLX is an index indicating a reference picture stored in a reference picture list. Note that LX is the notation method used when L0 prediction and L1 prediction are not being distinguished from each other, and by replacing LX with L0 or L1, the parameters for the L0 list may be distinguished from the parameters for the L1 list. For example, refIdxL0 denotes the reference picture index used in L0 prediction, refIdxL1 denotes the reference picture index used in L1 prediction, and refIdx (refldxLX) is the notation used when refIdxL0 and refIdxL1 are not being distinguished from each other.

The merge index merge_idx is an index indicating whether some prediction parameters among the prediction parameter candidates (merge candidates) derived from a block whose processing has been completed are to be used as prediction parameters for the block to be decoded.

(Motion Vector and Disparity Vector)

The vector mvLX includes a motion vector and a disparity vector (parallax vector). A motion vector refers to a vector indicating a shift of position between the position of a block in a picture in a certain layer at a certain display time, and the position of a corresponding block in a picture in the same layer at a different display time (for example, a neighboring discrete time). A disparity vector refers to a vector indicating a shift of position between the position of a block in a picture in a certain layer at a certain display time, and the position of a corresponding block in a picture in a different layer at the same display time. The pictures in different layers may be pictures from different views, pictures with different resolutions, or the like. Particularly, a disparity vector corresponding to pictures from different views is called a parallax vector. In the following description, the motion vector and the disparity vector simply will be called the vector mvLX when not being distinguished from each other. The prediction vector and the difference vector related to the vector mvLX are called the prediction vector mvpLX and the difference vector mvdLX, respectively. The reference picture index refldxLX associated with the vectors is used to indicate whether the vector mvLX and the difference vector mvdLX are motion vectors or disparity vectors.

(Configuration of Image Decoding Device)

Next, a configuration of the image decoding device 31 according to the present embodiment will be described. FIG. 5 is a schematic diagram illustrating a configuration of the image decoding device 31 according to the present embodiment. The image decoding device 31 is configured to include an entropy decoder 301, a prediction parameter decoder 302, reference picture memory (reference image storage, frame memory) 306, prediction parameter memory (prediction parameter storage, frame memory) 307, a predicted image generator 308, an inverse quantization/inverse DCT section 311, an adder 312, residual storage 313 (residual recording section), and a depth DV deriver 351 (not illustrated).

Additionally, the prediction parameter decoder 302 is configured to include an inter prediction parameter decoder 303 and an intra prediction parameter decoder 304. The predicted image generator 308 is configured to include an inter-predicted image generator 309 and an intra-predicted image generator 310.

The entropy decoder 301 performs entropy decoding on the coded stream Te input from an external source, separating and decoding individual codes (syntax elements). The separated codes include prediction information for generating a predicted image, and residual information for generating a difference image.

The entropy decoder 301 outputs some of the separated codes to the prediction parameter decoder 302. Some of the separated codes refers to, for example, the prediction mode PredMode, the partition mode part_mode, the merge flag merge_flag, the merge index merge_idx, the inter prediction flag inter_pred_idc, the reference picture index refldxLX, the prediction vector index mvp_LX_idx, the difference vector mvdLX, the residual prediction weight index iv_res_pred_weight_idx, and the illumination compensation flag ic_flag. Control of whether or not to decode which codes is conducted on the basis of instructions by the prediction parameter decoder 302. The entropy decoder 301 outputs quantized coefficients to the inverse quantization/inverse DCT section 311. The quantized coefficients are coefficients obtained by performing the discrete cosine transform (DCT) and quantization on a residual signal in the coding process. The entropy decoder 301 outputs a depth DV transform table DepthToDisparityB to the depth DV deriver 351. The depth DV transform table DepthToDisparityB is a table for transforming the pixel values of a depth image to parallax indicating the disparity between view images, and an element DepthToDisparityB[d] of the depth DV transform table DepthToDisparityB may be computed using a slope cp_scale, an offset cp_off, and a slop precision cp_precision according to the following expressions.

log 2 Div=BitDepth_{Y}−1+cp_precision

offset=(cp_off<<BitDepthY)+((1<<log 2 Div)>>1)

scale=cp_scale

DepthToDisparityB[d]=(scale*d+offset)>>log 2 Div

The parameters cp_scale, cp_off, and cp_precision are decoded from a referenced parameter set in the coded data for each view. Note that BitDepthY indicates the bit depth of the pixel value corresponding to the luma signal, and takes a value of 8, for example.

The prediction parameter decoder 302 receives some of the codes from the entropy decoder 301 as input. The prediction parameter decoder 302 decodes prediction parameters corresponding to the prediction mode indicated by the prediction mode PredMode, which is part of the subset. The prediction parameter decoder 302 outputs the prediction mode PredMode and the decoded prediction parameters to the prediction parameter memory 307 and the predicted image generator 308.

The inter prediction parameter decoder 303 decodes inter prediction parameters by referencing prediction parameters stored in the prediction parameter memory 307 on the basis of the codes input from the entropy decoder 301. The inter prediction parameter decoder 303 outputs decoded inter prediction parameters to the predicted image generator 308, and also stores the decoded inter prediction parameters in the prediction parameter memory 307. The inter prediction parameter decoder 303 will be discussed in detail later.

The intra prediction parameter decoder 304 decodes intra prediction parameters by referencing prediction parameters stored in the prediction parameter memory 307 on the basis of the codes input from the entropy decoder 301. Intra prediction parameters refer to parameters used in a process of predicting a picture block within a single picture, such as the intra prediction mode IntraPredMode, for example. The intra prediction parameter decoder 304 outputs decoded intra prediction parameters to the predicted image generator 308, and also stores the decoded intra prediction parameters in the prediction parameter memory 307.

The intra prediction parameter decoder 304 may also derive different intra prediction modes for luma and chroma. In this case, the intra prediction parameter decoder 304 decodes a luma prediction mode IntraPredModeY as a prediction parameter for luma, and a chroma prediction mode IntraPredModeC as a prediction parameter for chroma. The luma prediction mode IntraPredModeY has 35 modes, supporting planar prediction (0), DC prediction (1), and directional prediction (2 to 34). The chroma prediction mode IntraPredModeC uses one of planar prediction (0), DC prediction (1), directional prediction (2, 3, 4), and LM mode (5).

The reference picture memory 306 stores a block of a reference picture generated by the adder 312 (reference picture block) at a predetermined position for each picture and block to be decoded.

The prediction parameter memory 307 stores prediction parameters at a predetermined position for each picture and block to be decoded. Specifically, the prediction parameter memory 307 stores inter prediction parameters decoded by the inter prediction parameter decoder 303, intra prediction parameters decoded by the intra prediction parameter decoder 304, and the prediction mode predMode separated by the entropy decoder 301. The stored inter prediction parameters may be, for example, the prediction list utilization flag predFlagLX (inter prediction flag inter_pred_idc), the reference picture index refldxLX, and the vector mvLX.

The prediction mode predMode and the prediction parameters from the prediction parameter decoder 302 are input into the predicted image generator 308. Additionally, the predicted image generator 308 reads out a reference picture from the reference picture memory 306. The predicted image generator 308 generates predicted picture blocks predSmaples (a predicted image) in the prediction mode indicated by the prediction mode predMode using the input prediction parameters and the retrieved reference picture.

At this point, when the prediction mode predMode is an inter prediction mode, the inter-predicted image generator 309 generates the predicted picture blocks predSmaples by inter prediction using the inter prediction parameters input from the inter prediction parameter decoder 303 and the retrieved reference picture. The predicted picture blocks predSmaples correspond to prediction units PU. A PU corresponds to part of a picture made up of multiple pixels and acting as the unit by which to conduct the prediction process as discussed earlier, or in other words, a decoding target block on which the prediction process is conducted at once.

The inter-predicted image generator 309 reads out from the reference picture memory 306 a reference picture block at a position indicated by the vector mvLX using the decoding target block as a reference point. The reference picture block is retrieved from a reference picture indicated by the reference picture index refldxLX with respect to the reference picture list (L0 list or L1 list) whose prediction list utilization flag predFlagLX is 1. The inter-predicted image generator 309 performs prediction on the retrieved reference picture block to generate the predicted picture blocks predSmaples. The inter-predicted image generator 309 outputs the generated predicted picture blocks predSmaples to the adder 312.

When the prediction mode predMode is an intra prediction mode, the intra-predicted image generator 310 performs intra prediction using the intra prediction parameters input from the intra prediction parameter decoder 304 and the retrieved reference picture. Specifically, the intra-predicted image generator 310 reads out from the reference picture memory 306 a decoding target picture, being a reference picture block in a predetermined range of decoding target blocks from among the already-decoded blocks. In the case when the block to be decoded moves sequentially in what is called the raster scan order, for example, the predetermined range is one of the neighboring blocks to the left, upper-left, above, and upper-right, depending on the intra prediction mode. The raster scan order refers to the order of moving sequentially from the left edge to the right edge on each row from the top edge to the bottom edge in each picture.

The intra-predicted image generator 310 generates predicted picture blocks by performing prediction in the prediction mode indicated by the intra prediction mode IntraPredMode for the retrieved reference picture block. The intra-predicted image generator 310 outputs the generated predicted picture blocks predSmaples to the adder 312.

In the intra prediction parameter decoder 304, in the case of deriving different intra prediction modes for luma and chroma, the intra-predicted image generator 310 generates predicted picture blocks for luma by one of planar prediction (0), DC prediction (1), and directional prediction (2 to 34) according to the luma prediction mode IntraPredModeY, and generates predicted picture blocks for chroma by one of planar prediction (0), DC prediction (1), directional prediction (2, 3, 4), and LM mode (5) according to the chroma prediction mode IntraPredModeC.

The inverse quantization/inverse DCT section 311 computes DCT coefficients by inversely quantizing the quantized coefficients input from the entropy decoder 301. The inverse quantization/inverse DCT section 311 performs the inverse discrete cosine transform (DCT) on the computed DCT coefficients, and derives a decoded residual signal. The inverse quantization/inverse DCT section 311 outputs the computed decoded residual signal to the adder 312 and the residual storage 313.

The adder 312 generates reference picture blocks by adding together, for each pixel, the predicted picture blocks predSmaples input from the inter-predicted image generator 309 and the intra-predicted image generator 310, and the signal values of the decoded residual signal input from the inverse quantization/inverse DCT section 311. The adder 312 stores the generated reference picture blocks in the reference picture memory 306, and externally outputs the generated reference picture blocks to a decoded layer image Td combined for each picture.

(Configuration of Inter Prediction Parameter Decoder)

Next, a configuration of the inter prediction parameter decoder 303 will be described.

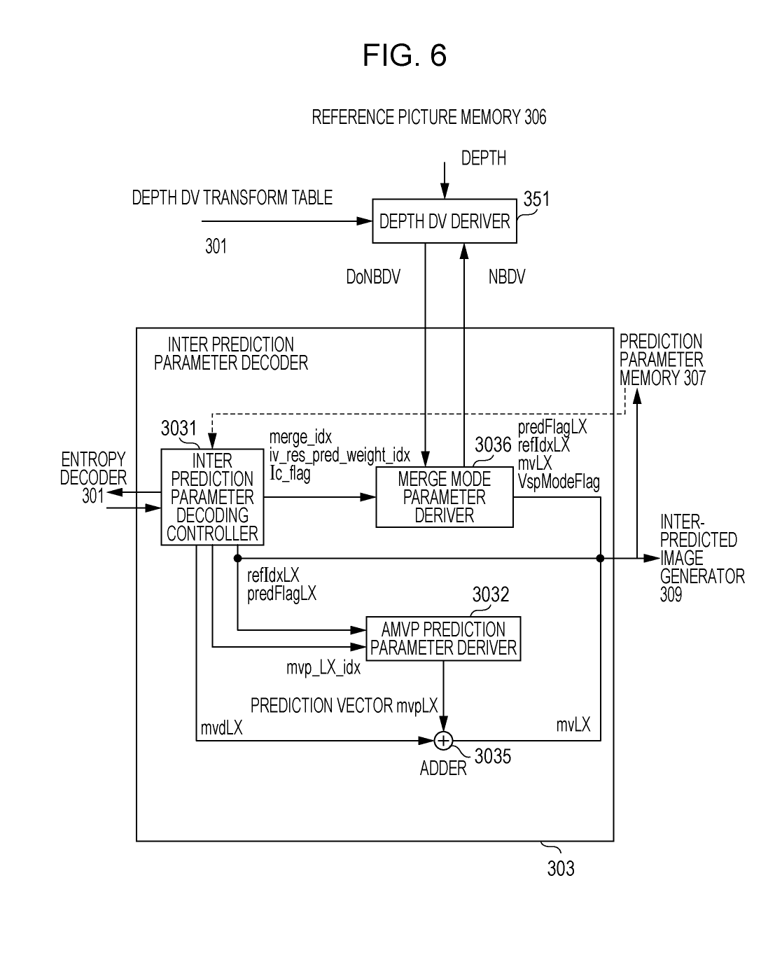

FIG. 6 is a schematic diagram illustrating a configuration of an inter prediction parameter decoder 303 according to the present embodiment. The inter prediction parameter decoder 303 is configured to include an inter prediction parameter decoding controller 3031, an AMVP prediction parameter deriver 3032, an adder 3035, and a merge mode parameter deriver 3036.

The inter prediction parameter decoding controller 3031 extracts codes (syntax elements) included in the coded data that instruct the entropy decoder 301 to decode codes (syntax elements related to inter prediction, such as the partition mode part_mode, the merge_flag merge_flag, the merge index merge_idx, the inter prediction flag inter_pred_idc, the reference picture index refIdxLX, the prediction vector index mvp_LX_idx, the difference vector mvdLX, the residual prediction weight index iv_res_pred_weight_idx, and the illumination compensation flag ic_flag.

The inter prediction parameter decoding controller 3031 first extracts the residual prediction weight index iv_res_pred_weight_idx and the illumination compensation flag ic_flag from the coded data. The expression stating that the inter prediction parameter decoding controller 3031 extracts a certain syntax element means that the inter prediction parameter decoding controller 3031 instructs the entropy decoder 301 to decode a certain syntax element, and reads out the relevant syntax element from the coded data.

Next, the inter prediction parameter decoding controller 3031 extracts the merge_flag from the coded data. At this point, when the merge_flag merge_flag indicates a value of 1, or in other words indicates merge mode, the inter prediction parameter decoding controller 3031 extracts the merge index merge_idx as a prediction parameter related to merge mode. The inter prediction parameter decoding controller 3031 outputs the extracted residual prediction weight index iv_res_pred_weight_idx, the illumination compensation flag ic_flag, and the merge index merge_idx to the merge mode parameter deriver 3036.

When the merge_flag merge_flag indicates a value of 0, or in other words indicates AMVP prediction mode, the inter prediction parameter decoding controller 3031 extracts AMVP prediction parameters from the coded data using the entropy decoder 301. The AMVP prediction parameters may be, for example, the inter prediction flag inter_pred_idc, the reference picture index refIdxLX, the vector index mvp_LX_idx, and the difference vector mvdLX. The inter prediction parameter decoding controller 3031 outputs the prediction list utilization flag predFlagLX derived from the extracted inter prediction flag inter_pred_idc and the reference picture index refIdxLX to the AMVP prediction parameter deriver 3032 and the predicted image generator 308 (FIG. 5), and also stores the above in the prediction parameter memory 307 (FIG. 5). The inter prediction parameter decoding controller 3031 outputs the extracted vector index mvp_LX_idx to the AMVP prediction parameter deriver 3032. The inter prediction parameter decoding controller 3031 outputs the extracted difference vector mvdLX to the adder 3035.

In addition, the inter prediction parameter decoding controller 3031 outputs a disparity vector (NBDV) derived at the time of the inter prediction parameter derivation, as well as a VSP mode flag VSPModeFlag which is a flag indicating whether or not to perform view synthesis prediction, to the inter-predicted image generator 309.

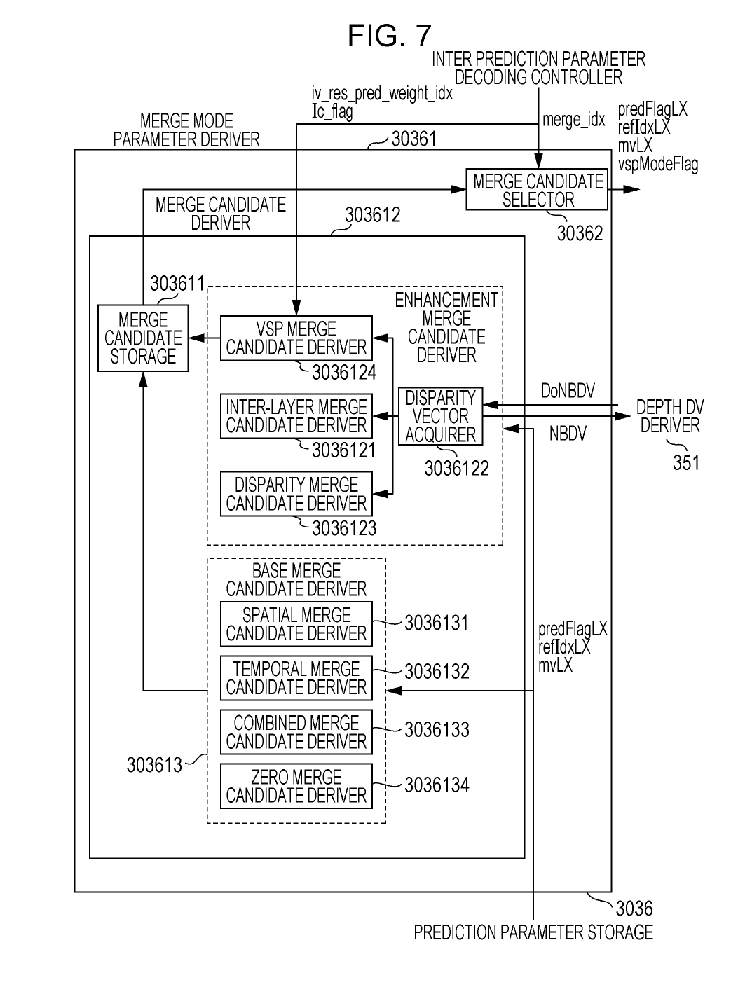

FIG. 7 is a schematic diagram illustrating a configuration of the merge mode parameter deriver 3036 according to the present embodiment. The merge mode parameter deriver 3036 is equipped with a merge candidate deriver 30361 and a merge candidate selector 30362. The merge candidate deriver 30361 is configured to include merge candidate storage 303611, an enhanced merge candidate deriver 303612, and a base merge candidate deriver 303613.

The merge candidate storage 303611 stores merge candidates input from the enhancement merge candidate deriver 303612 and the base merge candidate deriver 303613 in a merge candidate list mergeCandList. Note that a merge candidate is configured to include the prediction list utilization flag predFlagLX, the vector mvLX, the reference picture index refldxLX, the VSP mode flag VspModeFlag, the disparity vector MvDisp, and the layer ID RefViewIdx. In the merge candidate storage 303611, an index is assigned to the merge candidates stored in the merge candidate list mergeCandList according to a designated rule. For example, “0” is assigned as the index to merge candidates input from the enhancement merge candidate deriver 303612. Note that when the VSP mode flag VspModeFlag of a merge candidate is 0, the X and Y components of the disparity vector MvDisp are treated as being 0, and the layer ID refViewIdx is treated as being −1.

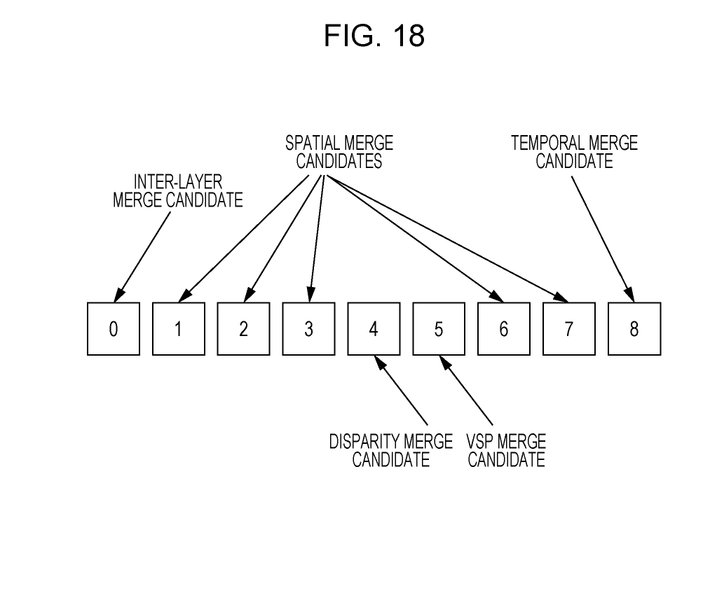

FIG. 18 illustrates an example of the merge candidate list mergeCandList derived by the merge candidate storage 303611. Excluding the process of skipping when two merge candidates have the same prediction parameters, the merge index order goes in the order of inter-layer merge candidates, spatial merge candidates (lower-left), spatial merge candidates (upper-right), spatial merge candidates (upper-right), disparity merge candidates, view synthesis prediction (VSP) merge candidates, spatial merge candidates (lower-left), spatial merge candidates (upper-left), and temporal merge candidates. The above are also followed by combined merge candidates, and zero merge candidates, but are omitted in FIG. 18.

The enhancement merge candidate deriver 303612 is configured to include a disparity vector acquirer 3036122, an inter-layer merge candidate deriver 3036121, a disparity merge candidate deriver 3036123, and a view synthesis prediction merge candidate deriver 3036124 (VSP merge candidate deriver 3036124).

The disparity vector acquirer 3036122 first acquires disparity vectors in order from multiple candidate blocks neighboring the decoding target block (for example, the blocks neighboring to the left, above, and to the upper-right). Specifically, one candidate block is selected, a reference layer determiner 303111 (discussed later) determines whether the vector of the selected candidate block is a disparity vector or a motion vector by using the reference picture index refldxLX of the candidate block, and if a disparity vector, treats the vector as a disparity vector. If the candidate block does not have a disparity vector, the next candidate block is scanned in order. If a disparity vector is not present in the neighboring blocks, the disparity vector acquirer 3036122 attempts to acquire the disparity vector of a block at a position corresponding to the target block among the blocks included in a reference picture of a temporally different display order. If a disparity vector cannot be acquired, the disparity vector acquirer 3036122 sets the zero vector as the disparity vector. The obtained disparity vector is called the neighboring block-based disparity vector (NBDV). The disparity vector acquirer 3036122 outputs the obtained NBDV to the depth DV deriver 351, and receives the horizontal component of a depth-based DV derived by the depth DV deriver 351 as input. The disparity vector acquirer 3036122 obtains a disparity vector that has been updated by replacing the horizontal component of the NBDV with the horizontal component of the depth-based DV input from the depth DV deriver 351 (the vertical component of the NBDV remains the same). The updated disparity vector is called the depth-oriented neighboring block-based disparity vector (DoNBDV). The disparity vector acquirer 3036122 outputs the disparity vector (DoNBDV) to the inter-layer merge candidate deriver 3036121, the disparity merge candidate deriver 3036123, and the view synthesis prediction merge candidate deriver (VSP merge candidate deriver) 3036124. Furthermore, the obtained disparity vector (NBDV) is output to the inter-predicted image generator 309.

The disparity vector from the disparity vector acquirer 3036122 is input into the inter-layer merge candidate deriver 3036121. The inter-layer merge candidate deriver 3036121 selects a block, indicated by just the disparity vector input from the disparity vector acquirer 3036122, from within a picture having the same POC as a decoding target picture in a separate layer (for example, the base layer or base view), and reads out from the prediction parameter memory 307 the prediction parameters which are the motion vector of the relevant block. More specifically, the prediction parameters read out by the inter-layer merge candidate deriver 3036121 are the prediction parameters of the block that includes the coordinates obtained by adding the disparity vector to the coordinates of the origin, the origin in this case being the center point of the target block.

The reference block coordinates (xRef, yRef) are derived according to

xRef=Clip3(0,PicWidthInSamples_{L}−1,xP+((nPSW−1)1)+((mvDisp[0]+2)>>2))

yRef=Clip3(0,PicHeightInSamples_{L}−1,yP+((nPSH−1)>>1)+((mvDisp[1]+2)>>2))

where (xP, yP) are the coordinates of the target block, (mvDisp[0], mvDisp[1]) is the disparity vector, and nPSW and nPSH are the width and height of the target block. Note that PicWidthInSamples_{L}, and PicHeightInSamples_{L} represent the width and height of the image, respectively, while the function Clip3(x, y, z) is a function that limits (clips) z to be equal to or greater than x and less than or equal to y, and returns the clipped result.

Note that the inter-layer merge candidate deriver 3036121 determines whether or not the prediction parameters are a motion vector according to a method in which a false determination (not a disparity vector) is made in the determination method of the reference layer determiner 303111 (discussed later) included in the inter prediction parameter decoding controller 3031. The inter-layer merge candidate deriver 3036121 outputs the read-out prediction parameters to the merge candidate storage 303611 as merge candidates. In addition, when the inter-layer merge candidate deriver 3036121 is unable to derive prediction parameters, an indication thereof is output to the disparity merge candidate deriver 3036123. This merge candidate is also referred to as the inter-layer candidate (inter-view candidate) for motion prediction, and the inter-layer merge candidate (motion prediction).

The disparity vector from the disparity vector acquirer 3036122 is input into the disparity merge candidate deriver 3036123. The disparity merge candidate deriver 3036123 generates a vector having the horizontal component of the input disparity vector as the horizontal component, and 0 as the vertical component. The disparity merge candidate deriver 3036123 outputs the generated vector and the reference picture index refIdxLX of the layer image that the disparity vector points to (for example, the index of the base layer image having the same POC as the decoding target picture) to the merge candidate storage 303611 as a merge candidate. This merge candidate is also referred to as the inter-layer candidate (inter-view candidate) for disparity prediction, and the inter-layer merge candidate (disparity prediction).

The VSP merge candidate deriver 3036124 derives view synthesis prediction (VSP) merge candidates. A VSP merge candidate is a merge candidate used during a predicted image generation process by view synthesis prediction conducted by the inter-predicted image generator 309. The disparity vector from the disparity vector acquirer 3036122 is input into the VSP merge candidate deriver 3036124. The VSP merge candidate deriver 3036124 derives VSP merge candidates by setting the input disparity vector mvDisp to the vector mvLX and the disparity vector MvDisp, setting the reference picture index of the reference picture indicating the layer image indicated by the disparity vector to the reference picture index refldxLX, setting the layer ID refViewIdx of the layer indicated by the disparity vector to the layer ID RefViewIdx, and setting the VSP mode flag VspModeFlag to 1. The VSP merge candidate deriver 3036124 outputs the derived VSP merge candidate to the merge candidate storage 303611.

The VSP merge candidate deriver 3036124 of the present embodiment receives the residual prediction weight index iv_res_pred_weight_idx and the illumination compensation flag ic_flag from the inter prediction parameter decoding controller as input. The VSP merge candidate deriver 3036124 conducts the VSP merge candidate derivation process only when the residual prediction weight index iv_res_pred_weight_idx is 0 and the illumination compensation flag ic_flag is 0. In other words, a VSP merge candidate is added to the elements of the merge candidate list mergeCandList only when the residual prediction weight index iv_res_pred_weight_idx is 0 and the illumination compensation flag ic_flag is 0. Conversely, the VSP merge candidate deriver 3036124 does not add a VSP merge candidate to the elements of the merge candidate list mergeCandList when the residual prediction weight index iv_res_pred_weight_idx is other than 0 or the illumination compensation flag ic_flag is other than 0. Consequently, when residual prediction or illumination compensation prediction is performed, or in other words, when view synthesis prediction is not performed, an effect of improving the coding efficiency is exhibited because of the reduction in the amount of calculation due to skipping the process of deriving unused VSP merge candidates and the reduction of variations in the merge index merge_idx by preventing increases in merge candidates.

Note that a configuration that conducts only residual prediction and does not conduct illumination compensation prediction is also possible. In this configuration, the VSP merge candidate deriver 3036124 conducts the VSP merge candidate derivation process only when the residual prediction weight index iv_res_pred_weight_idx is 0. In other words, a VSP merge candidate is added to the elements of the merge candidate list mergeCandList only when the residual prediction weight index iv_res_pred_weight_idx is 0. Conversely, a VSP merge candidate is not added to the elements of the merge candidate list mergeCandList when the residual prediction weight index iv_res_pred_weight_idx is other than 0.

Note that a configuration that conducts only illumination compensation prediction and does not conduct residual prediction is also possible. In this configuration, the VSP merge candidate deriver 3036124 conducts the VSP merge candidate derivation process only when the illumination compensation flag ic_flag is 0. In other words, a VSP merge candidate is added to the elements of the merge candidate list mergeCandList only when the illumination compensation flag ic_flag is 0. Conversely, a VSP merge candidate is not added to the elements of the merge candidate list mergeCandList when the illumination compensation flag ic_flag is other than 0.

The base merge candidate deriver 303613 is configured to include a spatial merge candidate deriver 3036131, a temporal merge candidate deriver 3036132, a combined merge candidate deriver 3036133, and a zero merge candidate deriver 3036134.

The spatial merge candidate deriver 3036131 reads out prediction parameters (the prediction list utilization flag predFlagLX, the vector mvLX, and the reference picture index refIdxLX) stored by the prediction parameter memory 307 according to a designated rule, and derives the read-out prediction parameters as a spatial merge candidate. The prediction parameters to be read out are prediction parameters related to each of neighboring blocks within a predetermined range from the decoding target block (for example, all or some of the blocks respectively adjacent to the lower-left corner, the upper-left corner, and the upper-right corner of the decoding target block). The derived spatial merge candidates are stored in the merge candidate storage 303611.

In the spatial merge candidate deriver 3036131, the VSP mode flag VspModeFlag of a neighboring block is inherited as the VSP mode flag VspModeFlag of a spatial merge candidate. In other words, when the VSP mode flag VspModeFlag of the neighboring block is 1, the VSP mode flag VspModeFlag of the corresponding spatial merge candidate is treated as 1, otherwise the VSP mode flag VspModeFlag is treated as 0.

Furthermore, when the VSP mode flag VspModeFlag of the neighboring block is 1, the spatial merge candidate deriver 3036131 also inherits the disparity vector of the neighboring block and the layer ID of the layer indicated by the disparity vector. In other words, the spatial merge candidate deriver 3036131 respectively sets the disparity vector mvDisp of the neighboring block and the layer ID refViewIdx of the layer indicated by the disparity vector of the neighboring block as the disparity vector MvDisp and the layer ID RefViewIdx of the spatial merge candidate.

Hereinafter, in the temporal merge candidate deriver 3036132, the combined merge candidate deriver 3036133, and the zero merge candidate deriver 3036134, the VSP mode flag VspModeFlag is set to 0.

The temporal merge candidate deriver 3036132 reads out the prediction parameters of a block in a reference image including coordinates to the lower-right of the decoding target block from the prediction parameter memory 307, and treats the read-out prediction parameters as a merge candidate. The method of specifying a reference image may be specifying using the reference picture index refldxLX specified in the slice header, or the smallest reference picture index refldxLX among the blocks neighboring the decoding target block, for example. The derived merge candidates are stored in the merge candidate storage 303611.

The combined merge candidate deriver 3036133 derives a combined merge candidate by combining the vector and reference picture index of two different, already-derived merge candidates stored in the already-derived merge candidate storage 303611 as L0 and L1 vectors, respectively. The derived merge candidates are stored in the merge candidate storage 303611.

The zero merge candidate deriver 3036134 derives a merge candidate in which the reference picture index refIdxLX is 0, and the X component and Y component of the vector mvLX are both 0. The derived merge candidates are stored in the merge candidate storage 303611.

The merge candidate selector 30362 selects, as the inter prediction parameters of the target PU, the merge candidate assigned with the index corresponding to the merge index merge_idx input from the inter prediction parameter decoding controller 3031 from among the merge candidates being stored in the merge candidate storage 303611. In other words, provided that mergeCandList is the merge candidate list, the prediction parameters indicated by mergeCandList[merge_idx] are selected. The merge candidate selector 30362 stores the selected merge candidate in the prediction parameter memory 307 (FIG. 5), and also outputs the selected merge candidate to the predicted image generator 308 (FIG. 5).

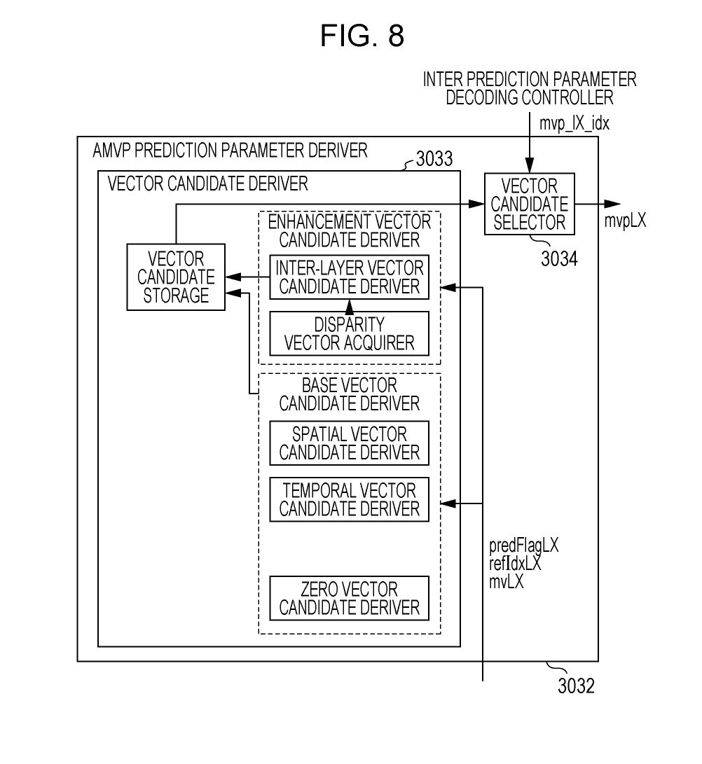

FIG. 8 is a schematic diagram illustrating a configuration of the AMVP prediction parameter deriver 3032 according to the present embodiment. The AMVP prediction parameter deriver 3032 is equipped with a vector candidate deriver 3033 and a prediction vector selector 3034. The vector candidate deriver 3033 reads out a vector (motion vector or disparity vector) stored by the prediction parameter memory 307 (FIG. 5) on the basis of the reference picture index refIdx as the vector candidate mvpLX. The vectors to be read out are vectors related to each of blocks within a predetermined range from the decoding target block (for example, all or some of the blocks respectively adjacent to the lower-left corner, the upper-left corner, and the upper-right corner of the decoding target block).

The prediction vector selector 3034 selects, as the prediction vector mvpLX, the vector candidate indicated by the vector index mvp_LX_idx input from the inter prediction parameter decoding controller 3031 from among the vector candidates read out by the vector candidate deriver 3033. The prediction vector selector 3034 outputs the selected prediction vector mvpLX to the adder 3035.

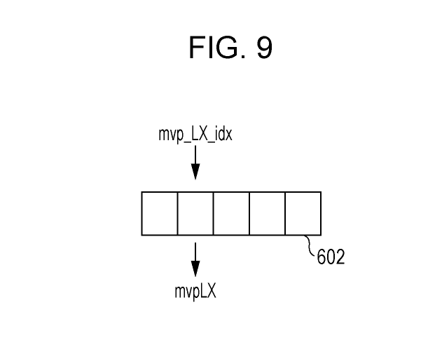

FIG. 9 is a conceptual diagram illustrating an example of vector candidates. The prediction vector list 602 illustrated in FIG. 9 is a list made up of multiple vector candidates derived by the vector candidate deriver 3033. In the prediction vector list 602, the five rectangles arranged in a row from left to right indicate respective regions indicating a prediction vector. The downward arrow underneath the second mvp_LX_idx from the left and the mvpLX farther below indicate that the vector index mvp_LX_idx is an index referencing the vector mvpLX in the prediction parameter memory 307.

A candidate vector is generated by referencing a block for which the decoding process is complete in a predetermined range from the decoding target block (for example, a neighboring block), and is generated on the basis of a vector related to the referenced block. Note that a neighboring block denotes not only a block obtained from blocks that spatially neighbor the target block, such as the left block and the top block, for example, but also a block obtained from blocks that temporally neighbor the target block, such as a block at the same position as the target block, but from a different display time, for example.

The adder 3035 adds together the prediction vector mvpLX input from the prediction vector selector 3034 and the difference vector mvdLX input from the inter prediction parameter decoding controller to compute the vector mvLX. The adder 3035 outputs the computed vector mvLX to the predicted image generator 308 (FIG. 5).

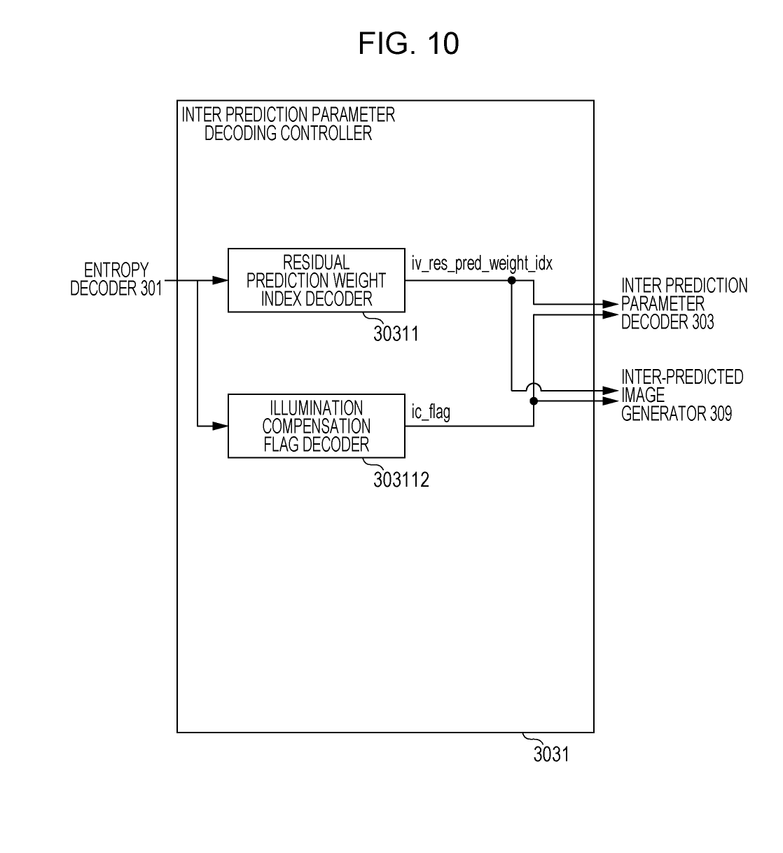

FIG. 10 is a block diagram illustrating a configuration of the inter prediction parameter decoding controller 3031 of the first embodiment. As illustrated in FIG. 10, the inter prediction parameter decoding controller 3031 is configured to include a residual prediction index decoder 30311, an illumination compensation decoder 30312, as well as the following which are not illustrated: a partition mode decoder, a merge_flag decoder, a merge index decoder, an inter prediction flag decoder, a reference picture index decoder, a vector candidate index decoder, and a vector difference decoder. The partition mode decoder, the merge flag decoder, the merge index decoder, the inter prediction flag decoder, the reference picture index decoder, the vector candidate index decoder, and the vector difference decoder decode the partition mode part_mode, the merge_flag merge_flag, the merge index merge_idx, the inter prediction flag inter_pred_idc, the reference picture index refldxLX, the prediction vector index mvp_LX_idx, and the difference vector mvdLX, respectively.

The residual prediction index decoder 30311 uses the entropy decoder 301 to decode the residual prediction weight index iv_res_pred_weight_idx. The residual prediction weight index decoder 30311 outputs the decoded residual prediction weight index iv_res_pred_weight_idx to the merge mode parameter deriver 3036 and the inter-predicted image generator 309.

The illumination compensation decoder 30312 uses the entropy decoder 301 to decode the illumination compensation flag ic_flag. The illumination compensation decoder 30312 outputs the decoded illumination compensation flag ic_flag to the merge mode parameter deriver 3036 and the inter-predicted image generator 309. When a block neighboring the target PU holds a disparity vector, the disparity vector acquirer extracts the disparity vector from the prediction parameter memory 307, references the prediction parameter memory 307, and reads out the prediction flag predFlagLX, the reference picture index refIdxLX, and the vector mvLX of the block neighboring the target PU. The disparity vector acquirer is internally provided with a reference layer determiner 303111. The disparity vector acquirer reads out the prediction parameters of the block neighboring the target PU in order, and uses the reference layer determiner 303111 to determine, from the reference picture index of the neighboring block, whether or not the neighboring block is provided with a disparity vector. When the neighboring block is provided with a disparity vector, the disparity vector is output. When a disparity vector does not exist in the prediction parameters of the neighboring block, the zero vector is output as the disparity vector.

(Reference Layer Determiner 303111)

The reference layer determiner 303111 determines, on the basis of the input reference picture index refIdxLX, the reference picture that the reference picture index refIdxLX points to, and reference layer information reference_layer_info indicating the relationship with the target picture. The reference layer information reference_layer_info is information indicating whether the vector mvLX of the reference picture is a disparity vector or a motion vector.

Prediction in the case in which the layer of the target picture and the layer of the reference picture are the same is called intra-layer prediction, and the vector obtained in this case is a motion vector. Prediction in the case in which the layer of the target picture and the layer of the reference picture are different is called inter-layer prediction, and the vector obtained in this case is a disparity vector.

(Inter-Predicted Image Generator 309)

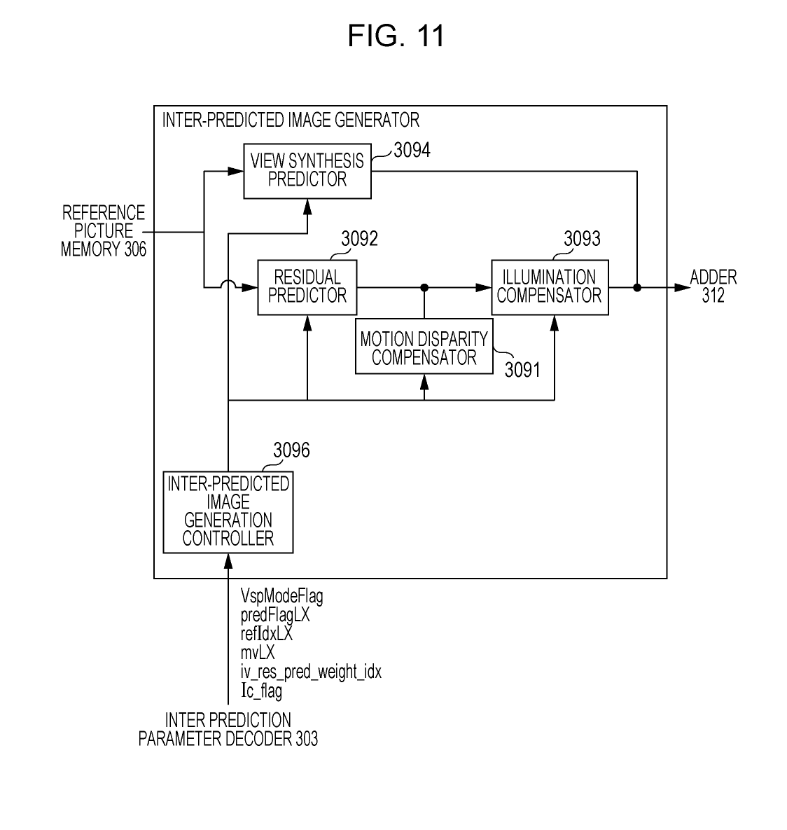

FIG. 11 is a schematic diagram illustrating a configuration of the inter-predicted image generator 309 according to the present embodiment. The inter-predicted image generator 309 is configured to include a motion/disparity compensator 3091, a residual predictor 3092, an illumination compensator 3093, a view synthesis predictor 3094, and an inter-predicted image generation controller 3096.

The inter-predicted image generation controller 3096 receives the VSP mode flag VspModeFlag and prediction parameters from the inter prediction parameter decoder 303. When the VSP mode flag VspModeFlag is 1, the inter-predicted image generation controller 3096 outputs the prediction parameters to the view synthesis predictor 3094. Also, when the VSP mode flag VspModeFlag is 0, the inter-predicted image generation controller 3096 outputs the prediction parameters to the motion/disparity compensator 3091, the residual predictor 3092, and the illumination compensator 3093. Also, when the residual prediction flag iv_res_pred_weight_idx is not 0 and the target block is motion compensation, the inter-predicted image generation controller 3096 outputs to the motion/disparity compensator 3091, sets the residual prediction execution flag resPredFlag to 1, which indicates the execution of residual prediction, and outputs to the residual predictor 3092. On the other hand, when the residual prediction flag iv_res_pred_weight_idx is 0 or the target block is not motion compensation (that is, the case of disparity compensation), the inter-predicted image generation controller 3096 sets the residual prediction execution flag resPredFlag to 0, and outputs to the motion/disparity compensator 3091 and the residual predictor 3092.

(Motion/Disparity Compensation)

The motion/disparity compensator 3091 generates a predicted image on the basis of the prediction list utilization flag predFlagLX, the reference picture index refldxLX, and the vector mvLX (motion vector of disparity vector), which are the prediction parameters input from the inter-predicted image generation controller 3096. The motion/disparity compensator 3091 generates a predicted image by reading out and interpolating a block at a positioned shifted by the vector mvLX from a point of origin at the position of a target block in the reference picture indicated by the reference picture index refIdxLX from the reference picture memory 306. At this point, if the vector mvLX is not an integer vector, the predicted image is generated after applying a filter for generating pixels at fractional positions, called a motion compensation filter (or a disparity compensation filter). Typically, the above process is called motion compensation when the vector mvLX is a motion vector, and called disparity compensation when the vector mvLX is a disparity vector. Herein, the collective term motion/disparity compensation will be used. Hereinafter, the predicted image of L0 prediction will be called predSamplesL0, and the predicted image of L1 prediction will be called predSamplesL1. When not being distinguished, predSamplesLX will be used. Hereinafter, an example of additionally conducting residual prediction and illumination compensation on the predicted image predSamplesLX obtained by the motion/disparity compensator 3091 will be described, but these output images will also be called the predicted image predSamplesLX. Note that when making a distinction between the input image and the output image in the following residual prediction and illumination compensation, the input image will be denoted by predSamplesLX, and the output image by predSamplesLX′.

(Residual Prediction)

When the residual prediction execution flag resPredFlag is 1, the residual predictor 3092 conducts residual prediction using the prediction parameters input from the inter-predicted image generation controller 3096. When the residual prediction execution flag resPredFlag is 0, the residual predictor 3092 does not conduct a process. The refResSamples residual prediction is conducted by adding the residual of a reference layer (first layer image) different from the target layer (second layer image) which is the target of predicted image generation to the predicted image predSamplesLX which is the predicted image of the target layer. In other words, it is assumed that a residual similar to the reference layer will also be produced in the target layer, and the already-derived residual of the reference layer is used as an estimated value of the residual of the target layer. In the base layer (base view), only images in the same layer become reference images. Consequently, when the reference layer (first layer image) is the base layer (base view), since the predicted image of the reference layer is a predicted image based on motion compensation, residual prediction is also effective in the prediction of the target layer (second layer image) in the case of a predicted image based on motion compensation. In other words, residual prediction has a property of being effective when the target block is motion compensation.

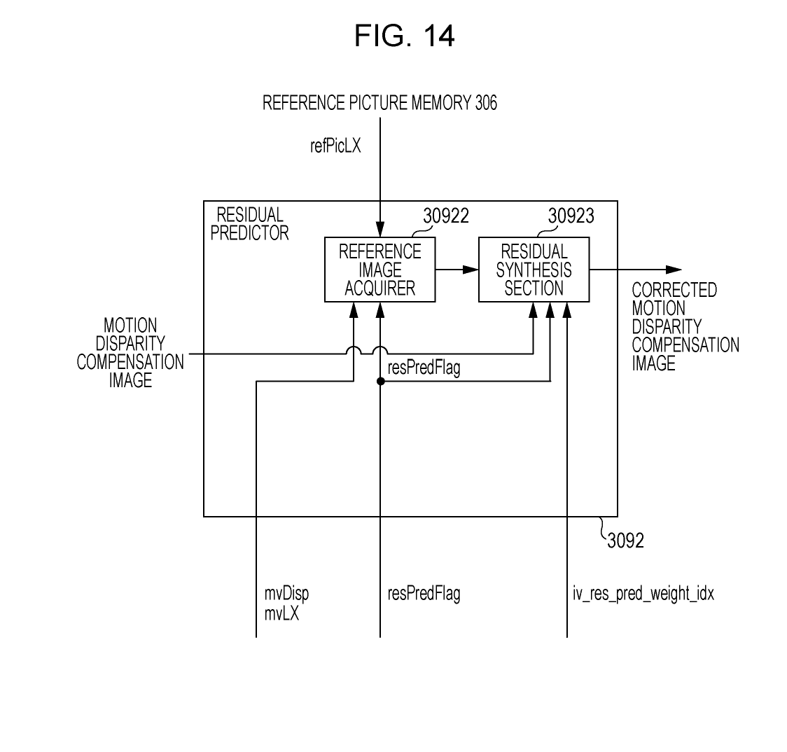

FIG. 14 is a block diagram illustrating a configuration of the residual predictor 3092. The residual predictor 3092 is made up of a reference image acquirer 30922 and a residual synthesis section 30923.

When the residual prediction execution flag resPredFlag is 1, the reference image acquirer 30922 reads out the motion vector mvLX and the residual prediction disparity vector mvDisp input from the inter prediction parameter decoder 303, as well as the corresponding block currIvSamplesLX and the reference block refIvSamplesLX of the corresponding block stored in the reference picture memory 306.

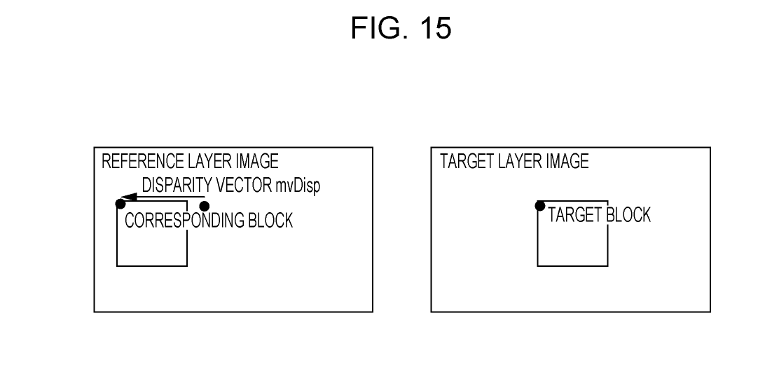

FIG. 15 is a diagram for explaining the corresponding block currIvSamplesLX. As illustrated in FIG. 15, the corresponding block that corresponds to the target block in the target layer is positioned on the block at a position shifted by the disparity vector mvDisp, which is a vector indicating the positional relationship between the reference layer and the target layer, from a point of origin at the position of the target block of the image in the reference layer.

Specifically, the reference image acquirer 30922 derives the pixels at the positions shifted by the disparity vector mvDisp of the target block from the coordinates (x, y) of the pixels in the target block. Considering that the disparity vector mvDisp has a fractional precision of ¼ pels, the reference image acquirer 30922 derives the X coordinate xInt and the Y coordinate yInt of the pixel R0 of integer precision corresponding to the case in which the coordinates of the pixel of the target block are (xP, yP), as well as the fractional X component xFrac and the fractional Y component yFrac of the disparity vector mvDisp, according to the following expressions.

xInt=xPb+(mvLX[0]>>2)

yInt=yPb+(mvLX[1]>>2)

xFrac=mvLX[0]& 3

yFrac=mvLX[1]&3

Herein, X & 3 is a mathematical formula that retrieves only the two least-significant bits of X.

Next, considering that the disparity vector mvDisp has a fractional precision of ¼ pels, the reference image acquirer 30922 generates interpolated pixels predPartLX[x] [y]. First, the coordinates of integer pixels A (xA, yB), B (xB, yB), C (xC, yC), and D (xD, yD) are derived according to the following expressions.

xA=Clip3(0,picWidthInSamples−1,xInt)

xB=Clip3(0,picWidthInSamples−1,xInt+1)

xC=Clip3(0,picWidthInSamples−1,xInt)

xD=Clip3(0,picWidthInSamples−1,xInt+1)

yA=Clip3(0,picHeightInSamples−1,yInt)

yB=Clip3(0,picHeightInSamples−1,yInt)

yC=Clip3(0,picHeightInSamples−1,yInt+1)

yD=Clip3(0,picHeightInSamples−1,yInt+1)

Herein, the integer pixel A is the pixel corresponding to the pixel R0, while the integer pixels B, C, and D are pixels of integer precision neighboring the integer pixel A to the right, below, and to the lower-right, respectively. The reference image acquirer 30922 reads out the reference pixels refPicLX[xA] [yA], refPicLX[xB] [yB], refPicLX[xC] [yC], and refPicLX[xD] [yD] corresponding to each integer pixel A, B, C, and D from the reference picture memory 306.

Subsequently, the reference image acquirer 30922 uses the reference pixels refPicLX [xA] [yA], refPicLX [xB] [yB], refPicLX [xC] [yC], and refPicLX [xD] [yD] as well as the fractional X component xFrac and the fractional Y component yFrac of the disparity vector mvDisp to derive the interpolated pixel predPartLX[x] [y], which is the pixel at the position shifted from the pixel R0 by the fractional part of the disparity vector mvDisp. Specifically, the interpolated pixel predPartLX[x] [y] is derived according to the following expression.

predPartLX[x][y]=(refPicLX[xA][yA]*(8−xFrac)*(8−yFrac)+refPicLX[xB][yB](8−yFrac)*xFrac+refPicLX[xC][yC]*(8−xFrac)*yFrac+refPicLX[xD][yD]*xFrac*yFrac)>>6

The reference image acquirer 30922 conducts the above interpolated pixel derivation process on each pixel within the target block, and takes the set of interpolated pixels to be an interpolated block predPartLX. The reference image acquirer 30922 outputs the derived interpolated block predPartLX to the residual synthesis section 30923 as the corresponding block currIvSamplesLX.

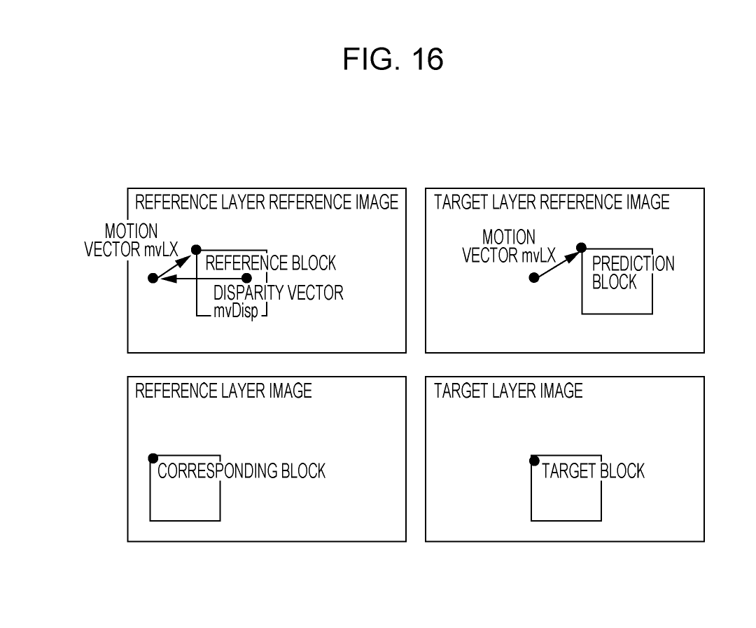

FIG. 16 is a diagram for explaining the reference block refIvSamplesLX. As illustrated in FIG. 16, the reference block that corresponds to the corresponding block in the reference layer is positioned on the block at a position shifted by the motion vector mvLX of the target block from a point of origin at the position of the corresponding block of the reference image in the reference layer.

The reference image acquirer 30922 derives the corresponding block refIvSamplesLX by conducting a process similar to the process of deriving the corresponding block currIvSamplesLX, except that the disparity vector mvDisp is substituted with the vector (mvDisp[0]+mvLX[0], mvDisp[1]+mvLX[1]). The reference image acquirer 30922 outputs the corresponding block refIvSamplesLX to the residual synthesis section 30923.

When the residual prediction execution flag resPredFlag is 1, the residual synthesis section 30923 derives a corrected predicted image predSamplesLX′ from the predicted image predSamplesLX, the corresponding block currIvSamplesLX, the reference block refIvSamplesLX, and the residual prediction flag iv_res_pred_weight_idx. The corrected predicted image predSamplesLX′ is computed using the following expression.

predSamplesLX′=predSamplesLX+((currIvSamplesLX−refIvSamplesLX)>>(iv_res_pred_weight_idx−1))

When the residual prediction execution flag resPredFlag is 0, the residual synthesis section 30923 outputs the predicted image predSamplesLX as-is.

(Illumination Compensation)

When the illumination compensation flag ic_flag is 1, the illumination compensator 3093 conducts illumination compensation on the input predicted image predSamplesLX. When the illumination compensation flag ic_flag is 0, the input predicted image predSamplesLX is output as-is. The predicted image predSamplesLX input into the illumination compensator 3093 is the output image of the motion/disparity compensator 3091 when the residual prediction execution flag resPredFlag is 0, and the output image of the residual predictor 3092 when the residual prediction execution flag resPredFlag is 1.

(View Synthesis Prediction)

When the VSP mode flag VspModeFlag is 1, the view synthesis predictor 3094 conducts view synthesis prediction using the prediction parameters input from the inter-predicted image generation controller 3096. When the VSP mode flag VspModeFlag is 0, the view synthesis predictor 3094 does not conduct a process. View synthesis prediction refers to a process of generating the predicted image predSamples by partitioning the target block into sub-blocks, and in units of sub-blocks, reading out and interpolating the block at the position shifted by the disparity sample array disparitySampleArray from the reference picture memory 306.

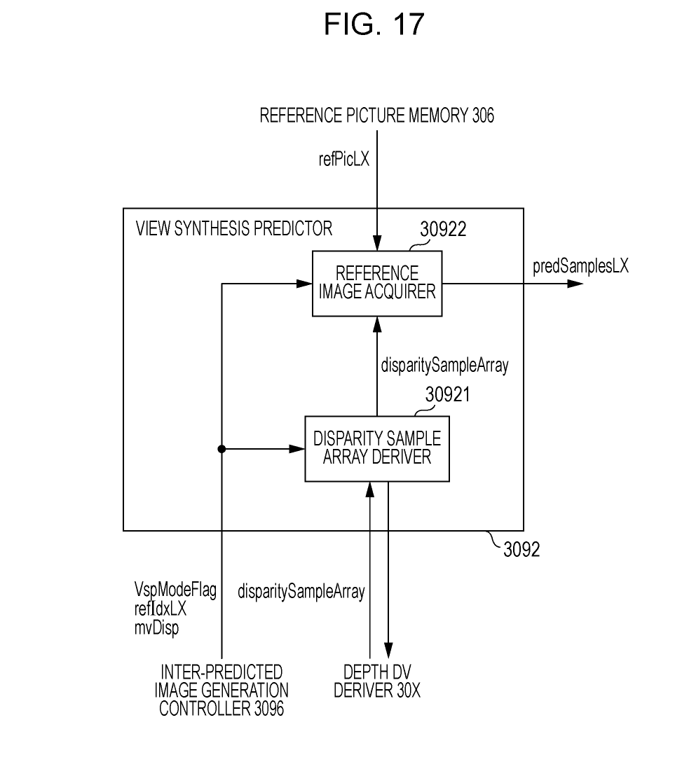

FIG. 17 is a block diagram illustrating a configuration of the view synthesis predictor 3094. The view synthesis predictor 3094 is made up of a disparity sample array deriver 30941 and a reference image acquirer 30942.

When the VSP mode flag VspModeFlag is 1, the disparity sample array deriver 30941 derives the disparity sample array disparitySampleArray in units of sub-blocks.

Specifically, first, the disparity sample array deriver 30941 reads out, from the reference picture memory 306, the depth image refDepPels having the same POC as the decoding target picture and also having the same layer ID as the layer ID RefViewIdx of the layer image indicated by the disparity vector. Note that the layer of the depth image refDepPels to read out may be the same layer as the reference picture indicated by the reference picture index refldxLX, or the same layer as the decoding target image.

Next, the disparity sample array deriver 30941 derives the coordinates (xTL, yTL) shifted by the disparity vector MvDisp from the upper-left coordinates (xP, yP) of the target block according to the following expressions.

xTL=xP+((mvDisp[0]+2)>>2)

yTL=yP+((mvDisp[1]+2)>>2)

Note that mvDisp[0] and mvDisp[1] are the X component and the Y component of the disparity vector MvDisp, respectively. The coordinates (xTL, yTL) to derive indicate the coordinates of the block corresponding to the target block in the depth image refDepPels.

The view synthesis predictor 3094 performs sub-block partitioning according to the size (width nPSW×height nPSH) of the target block (prediction unit).

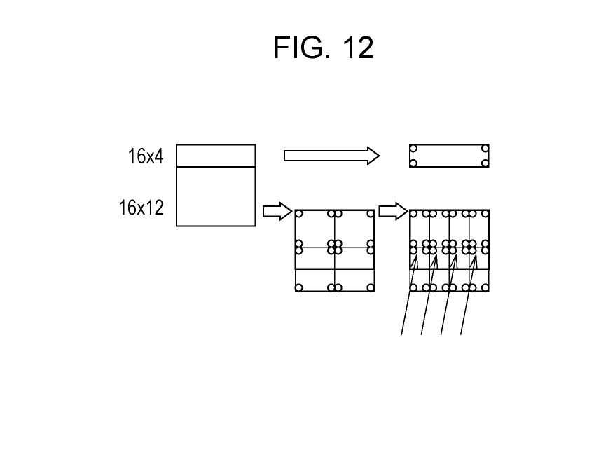

FIG. 12 is a diagram explaining the sub-block partitioning of a prediction unit in the case of a comparative example. In the case of the comparative example, the partition flag splitFlag is set to 1 if the width nPSW and the height nPSH of the prediction unit are both greater than 4, and set to 0 otherwise. If the partition flag splitFlag is 0, the prediction block is not partitioned, and the prediction block itself is simply treated as a sub-block. If the partition flag splitFlag is 1, the sub-block size is decided to be 8×4 or 4×8, with the decision made per 8×8 block constituting the prediction unit.

FIG. 12 illustrates an example of the case of performing view synthesis prediction on 16×4 and 16×12 prediction blocks in an asymmetric motion partition (AMP) block. As illustrated in FIG. 12, in the 16×4 case, the height is greater than 4, and thus the sub-block size becomes 16×4 without being partitioned. In the 16×12 case, the prediction block is partitioned into sub-blocks in units of 8×8 units. The drawing illustrates the case in which 4×8 sub-blocks are selected. In this case, when partitioning 16×4 into 8×8, in the lower 8×8, the common portions shared between the sub-blocks (4×8) in units for deriving disparity and the prediction units (16×12) become 4×4 blocks. For this reason, there is a possibility that the disparity derived with the sub-blocks will be used to perform motion/disparity prediction (motion prediction) in 4×4 units. Motion/disparity prediction in small 4×4 blocks requires more computation than in the case of performing motion/disparity prediction with large blocks.

The view synthesis predictor 3094 according to the present embodiment sets the partition flag splitFlag to 0 if the height or the width of the prediction unit is other than a multiple of 8, and sets the partition flag splitFlag to 1 otherwise.

Specifically, first, the view synthesis predictor 3094 derives the partition flag splitFlag according to the following expression.

splitFlag=((nPSW% 8)==0&&(nPSH% 8)==0)?1:0

Herein, nPSW % 8 is the remainder of the width of the prediction unit divided by 8, which becomes true (1) when the width of the prediction unit is other than a multiple of 8. Similarly, nPSH % 8 is the remainder of the height of the prediction unit divided by 8, which becomes true (1) when the height of the prediction unit is other than a multiple of 8.

Next, the disparity sample array deriver 30941 derives the width nSubBlkW and the height nSubBlkH of the sub-block according to the following expressions.

nSubBlkW=splitFlag?8:nPSW

nSubBlkH=splitFlag?8:nPSH

In other words, when the partition flag is 0 (that is, when the height or the width of the prediction unit is other than a multiple of 8), the width nSubBlkW and the height nSubBlkH of the sub-block are set to the width nPSW and the height nPSH of the prediction unit, respectively. When the partition flag is 1 (that is, when the height and the width of the prediction unit are multiples of 8), the width and the height of the sub-block are set to 8.

Next, the disparity sample array deriver 30941 outputs the sub-block width nSubBlkW and height nSubBlkH in the case of taking the upper-left pixel of the block as the origin, the split flag splitFlag, the depth image refDepPels, the coordinates (xTL, yTL) of the corresponding block, and the layer ID refViewIdx of the layer containing the reference picture indicated by the reference picture index refIdxLX to the depth DV deriver 351 for each of all sub-blocks within the target block, and thereby obtains the disparity sample array disparitySampleArray from the depth DV deriver 351. The disparity sample array deriver 30941 outputs the derived disparity sample array disparitySampleArray to the reference image acquirer 30942.

(Depth DV Deriver 351)

The depth DV deriver 351 derives a disparity sample array disparitySamples, which are the horizontal components of depth-derived disparity vectors, according to the following process by using the depth DV transform table DepthToDisparityB decoded from the coded data by the entropy decoder 301, the sub-block width nSubBlkW and height nSubBlkH obtained from the inter prediction parameter decoder 303, the split flag splitFlag, the depth image refDepPels, the coordinates (xTL, yTL) of a corresponding block in the depth image refDepPels, and the layer ID refViewIdx.

The depth DV deriver 351 uses multiple sub-sub-block corners and nearby points to derive a representative value of depth maxDep for each sub-sub-block obtained by further partitioning a sub-block constituting a block (prediction unit). Note that the prediction unit and the sub-sub-block may also be the same size. Specifically, first, the depth DV deriver 351 determines the sub-sub-block width nSubSubBlkW and height nSubSubBlkH. When the partition flag splitFlag is 1 (herein, when the height and width of the prediction unit are multiples of 8), provided that refDepPelsP0 is the pixel value of the depth image at the coordinates in the upper-left corner of the sub-block, refDepPelsP1 is the pixel value in the upper-right corner, refDepPelsP2 is the pixel value in the lower-left corner, and refDepPelsP3 is the pixel value in the lower-right corner, it is determined whether or not the following conditional expression (horSplitFlag) holds.

horSplitFlag=(refDepPelsP0>refDepPelsP3)==(refDepPelsP1>refDepPelsP2)

Next, the depth DV deriver 351 sets the width nSubSubBlkW and the height nSubSubBlkH of the sub-sub-block using the following expressions.

nSubSubBlkW=horSplitFlag?nSubBlkW:(nSubBlkW>>1)

nSubSubBlkH=horSplitFlag?(nSubBlkH>>1):nSubBlkH

In other words, if the conditional expression (horSplitFlag) holds, the width nSubSubBlkW of the sub-sub-block is set to the width nSubBlkW of the sub-block, and the height nSubSubBlkH of the sub-sub-block is set to half the height nSubBlkH of the sub-block. If the conditional expression (horSplitFlag) does not hold, the width nSubSubBlkW of the sub-sub-block is set to half the width nSubBlkW of the sub-block, and the height nSubSubBlkH of the sub-sub-block is set to the height nSubBlkH of the sub-block.

Since the width and height of the sub-block are 8 when the partition flag splitFlag is 1, the sub-sub-block becomes 4×8 or 8×4.

In addition, when the partition flag splitFlag is 0 (herein, when the height or the width of the prediction unit is other than a multiple of 8), the depth DV deriver 351 sets the width nSubSubBlkW and the height nSubSubBlkH of the sub-sub-block using the following expressions.

nSubSubBlkW=nSubBlkW(=nPSW)

nSubSubBlkH=nSubBlkH(=nPSH)

In other words, the width nSubSubBlkW and height nSubSubBlkH of the sub-sub-block are set to the same width nSubBlkW and height nSubBlkH as the sub-block. In this case, the prediction block itself simply becomes the sub-sub-block as described earlier.

Next, provided that (xSubB, ySubB) are the relative coordinates of the upper-left of the sub-sub-block, the depth DV deriver 351 derives the sub-sub-block X coordinate xP0 at the left edge, the X coordinate xP1 at the right edge, the Y coordinate yP0 at the top edge, and the Y coordinate yP1 at the bottom edge according to the following expressions.

xP0=Clip3(0,pic_width_in_luma_samples−1,xTL+xSubB)

yP0=Clip3(0,pic_height_in_luma_samples−1,yTL+ySubB)

xP1=Clip3(0,pic_width_in_luma_samples−1,xTL+xSubB+nSubSubBlkW−1)

yP1=Clip3(0,pic_height_in_luma_samples−1,yTL+ySubB+nSubSubBlkH−1)

Note that pic_width_in_luma_samples and pic_height_in_luma_samples represent the width and height of the image, respectively.

Next, the depth DV deriver 351 derives a representative value of the depth of the sub-sub-block. Specifically, the representative depth value maxDep, which is the maximum value of the pixel values refDepPels [xP0] [yP0], refDepPels [xP0] [yP1], refDepPels [xP1] [yP0], and refDepPels [xP1] [yP1] of the depth image at the corners of the sub-sub-block and four nearby points, is derived using the following expressions.

maxDep=0

maxDep=Max(maxDep,refDepPels[xP0][yP0])

maxDep=Max(maxDep,refDepPels[xP0][yP1])

maxDep=Max(maxDep,refDepPels[xP1][yP0])

maxDep=Max(maxDep,refDepPels[xP1][yP1])

Also, the function Max(x, y) is a function that returns x if a first argument x is equal to or greater than a second argument y, and returns y otherwise.

The depth DV deriver 351 uses the representative depth value maxDep, the depth DV transform table DepthToDisparityB, and the layer ID refViewIdx of the layer indicated by the disparity vector (NBDV) MvDisp to derive a disparity samples array disparitySamples, which are the horizontal components of depth-derived disparity vectors, for each pixel (x, y) within the sub-sub-block (where x takes a value from 0 to nSubSubBlkW−1, and y takes a value from 0 to nSubSubBlkH−1), using the following expression.

disparitySamples[x][y]=DepthToDisparityB[refViewIdx][maxDep] (Expression A)

The depth DV deriver 351 performs the above process on all sub-sub-blocks within the sub-block. The depth DV deriver 351 outputs the derived disparity sample array disparitySamples to the disparity vector acquirer 3036122 and the view synthesis predictor 3094.

When the VSP mode flag VspModeFlag is 1, the reference image acquirer 30942 derives the predicted block predSamples from the disparity sample array disparitySampleArray input from the disparity sample array deriver 30941 and the reference picture index refldxLX input from the inter prediction parameter decoder 303.

For each pixel in the target block, the reference image acquirer 30942 extracts, from the reference picture refPic indicated by the reference picture index refldxLX, the pixel at the position shifted in the X coordinate by the value of the corresponding disparity sample array disparitySampleArray from the coordinates of that pixel. Considering that the disparity sample array disparitySampleArray has a fractional precision of ¼ pels, when the coordinates of the pixel at the upper-left corner of the target block are (xP, yP), and the coordinates of each pixel in the target block are (xL, yL) (where xL takes a value from 0 to nPbW−1, and yL takes a value from 0 to nPbH−1), the reference image acquirer 30942 derives the coordinates (xInt, yInt) of integer precision of the pixel extracted from the reference picture refPic and the fractional parts xFrac and yFrac of the disparity sample array disparitySampleArray [xL] [yL] corresponding to the pixel (xL, yL) according to the following expressions.

xIntL=xP+xL+disparitySamples[xL][yL]

yIntL=yP+yL

xFracL=disparitySamples[xL][yL]&3

xFracL=0

Next, the reference image acquirer 30942 conducts an interpolated pixel derivation process similarly to the reference image acquirer 30922 on each pixel within the target block, and takes the set of interpolated pixels to be an interpolated block predPartLX. The reference image acquirer 30942 outputs the derived interpolated block predPartLX to the adder 312 as the predicted block predSamples.

As above, the image decoding device 31 according to the present embodiment is an image decoding device that generates and decodes a predicted image of a target prediction block, including a view synthesis predictor that generates a predicted image using view synthesis prediction. The view synthesis predictor partitions a prediction block into sub-sub-blocks according to whether or not the height or the width of the prediction block is other than a multiple of 8, and the view synthesis predictor derives a depth-derived disparity in units of the sub-sub-blocks. Specifically, when the height or the width of the prediction block is other than a multiple of 8, the view synthesis predictor does not partition the prediction block and instead treats the prediction block as the sub-sub-block, whereas when the height and the width of the prediction block are multiples of 8, the view synthesis predictor partitions the prediction block into a sub-sub-block less than the prediction block.

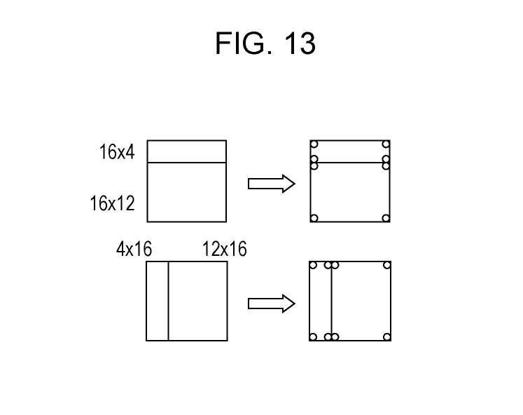

FIG. 13 is a diagram illustrating a process by the view synthesis predictor 3094 according to the present embodiment. In the case of AMP, when the prediction block is 16×4 or 16×12, the height of the prediction block is not a multiple of 8, and thus the partition flag becomes 0. In other words, the sub-block and the sub-sub-block become the same size as the prediction block. As a result, the disparity vector is derived in units of prediction units (in this case, 16×4 or 16×12). When the prediction block is 4×16 or 12×16, the width of the prediction block is not a multiple of 8, and thus the partition flag becomes 0. In this case, the disparity vector is derived in units of prediction units (in this case, 4×16 or 12×16).

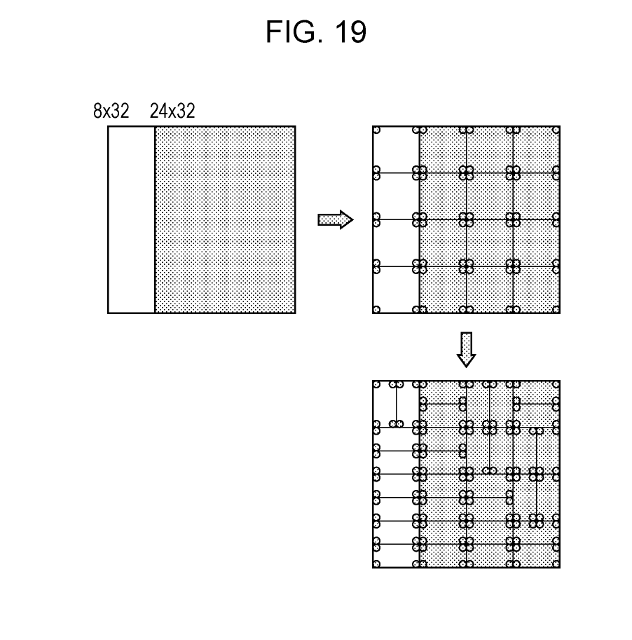

FIG. 19 is a diagram illustrating a process by the view synthesis predictor 3094 according to the present embodiment. In the case of AMP, when the width and the height of the prediction block are multiples of 8 (in the drawing, 8×32 or 24×32), the prediction block is partitioned into 8×8 sub-blocks, and further partitioned into 8×4 or 4×8 sub-sub-blocks per 8×8 sub-block. In the present embodiment, the boundary of the sub-sub-block does not cross the boundary of the prediction unit, and thus 4×4 blocks are not produced. In the view synthesis predictor 3094 according to the present embodiment, processing in blocks of 4×4 is not produced, unlike the comparative example in FIG. 12, and thus an advantage of reducing the amount of processing is exhibited.

Note that when the height and the width of the prediction block are multiples of 8, after partitioning the prediction block into 8×8 sub-blocks, the view synthesis predictor further partitions each sub-block into 8×4 or 4×8 sub-sub-blocks.

(Another Configuration of View Synthesis Predictor 3094)

Hereinafter, a view synthesis predictor 3094′ which is another configuration of the view synthesis predictor will be described as a second embodiment of the present invention.

The view synthesis predictor 3094′ according to the present embodiment sets the partition flag splitFlag to 1 when the coding unit that includes the prediction block is partitioned by AMP.

splitFlag=(nPSW>2×min(nPSH,nPSW-nPSH))∥(nPSH>2×min(nPSW,nPSH−nPSW))?1:0

When the partition flag splitFlag is 1, each sub-block is partitioned into 4×8 or 8×4 sub-sub-blocks, as described for the view synthesis predictor 3094.

On the other hand, when the partition flag splitFlag is 0 (herein, in the case of AMP), the following expressions are used to set the width nSubSubBlkW and the height nSubSubBlkH of the sub-sub-block to the same width nSubBlkW and height nSubBlkH of the sub-block.

nSubSubBlkW=nSubBlkW(=nPSW)

nSubSubBlkH=nSubBlkH(=nPSH)

Note that the same result for the sub-sub-block size may also be obtained with the following process.

If the width of the prediction block is longer than twice the height (nPSW>nPSH×2) or if the height of the prediction block is longer than twice the width (nPSH>nPSW×2), the disparity sample array deriver 30941 uses the following expressions to set the width nSubSubBlkW and the height nSubSubBlkH of the sub-sub-block to the same width nSubBlkW and height nSubBlkH of the sub-block.

nSubSubBlkW=nSubBlkW(=nPSW)

nSubSubBlkH=nSubBlkH(=nPSH)

The view synthesis predictor having the above configuration partitions the prediction block into sub-blocks according to whether or not the prediction block is an AMP block. Specifically, the view synthesis predictor treats the sub-sub-block as being the prediction block when the prediction block is an AMP block.

FIG. 13 is a diagram illustrating a process by the view synthesis predictor 3094′ according to the present embodiment. When the size of the coding unit (CU) including the prediction block is 16, or in other words, when the size of the prediction block is 16×4, 16×12, 4×16, or 12×16, the process is the same as the view synthesis predictor 3094.

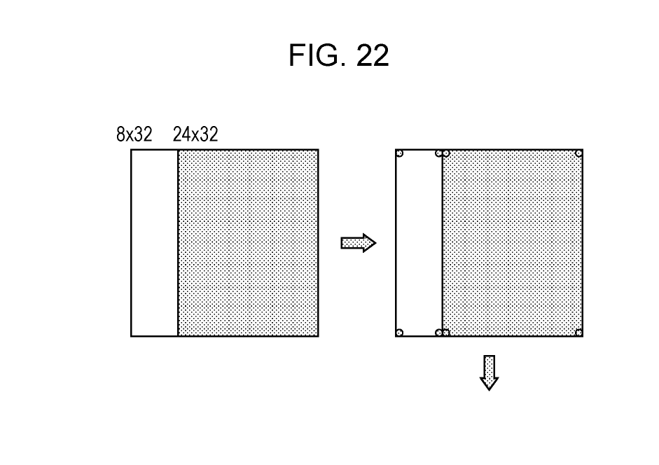

FIG. 22 is a diagram illustrating a process by the view synthesis predictor 3094′ according to the present embodiment in the case in which the size of the coding unit (CU) including the prediction block is greater than 16. In the case of AMP, when the width and the height of the prediction block are multiples of 8 (in the drawing, 8×32 or 24×32), the prediction block is not partitioned by the view synthesis predictor 3094. In other words, the size of the sub-sub-block becomes the same as the prediction block (in the drawing, 8×32 or 24×32).

In the view synthesis predictor 3094, in the case of AMP, the sub-sub-block is the same size as the prediction block, and thus the boundary of the sub-sub-block does not cross the boundary of the prediction unit, and 4×4 blocks are not produced. In the view synthesis predictor 3094 according to the present embodiment, processing in blocks of 4×4 is not produced, unlike the comparative example in FIG. 12, and thus an advantage of reducing the amount of processing is exhibited.

(Another Configuration of View Synthesis Predictor 3094)

Hereinafter, a view synthesis predictor 3094B which is another configuration of the view synthesis predictor will be described as a third embodiment of the present invention.

The view synthesis predictor 3094B according to the present embodiment sets the partition flag splitFlag to 1 in the case of view synthesis prediction.

splitFlag=1

The partition flag splitFlag is set to 1 so as to make the process of deriving a depth-derived disparity vector shared in common regardless of whether the sub-block and the sub-sub-block are the same size as the prediction unit (that is, the case of not partitioning) or not the same size as the prediction unit (that is, the case of partitioning), but in the case of dividing up the process, the partition flag splitFlag may also be derived as follows.

splitFlag=(!(nPSW% 8)&&!(nPSH% 8))?1:0

Next, the disparity sample array deriver 30941 derives the width nSubBlkW and the height nSubBlkH of the sub-block using the following expressions.

nSubBlkW=(!(nPSW% 8)&&!(nPSH% 8))?8:nPSW

nSubBlkH=(!(nPSW% 8)&&!(nPSH% 8))?8:nPSH

In other words, when the height or the width of the prediction unit is other than a multiple of 8, the width nSubBlkW and the height nSubBlkH of the sub-block are set to the width nPSW and the height nPSH of the prediction unit, respectively. When the height and the width of the prediction unit are multiples of 8, the width and the height of the sub-block are set to 8.

First, the disparity sample array deriver 30941 uses the following expressions to set the width nSubSubBlkW and the height nSubSubBlkH of the sub-sub-block to the same width nSubBlkW and height nSubBlkH of the sub-block.

nSubSubBlkW=nSubBlkW

nSubSubBlkH=nSubBlkH

When the height of the prediction unit is other than a multiple of 8 (when nPSH % 8 is true), the disparity sample array deriver 30941 sets the width nSubSubBlkW of the sub-sub-block to 8 and the height nSubSubBlkH of the sub-sub-block to 4 like the following expressions.

nSubSubBlkW=8

nSubSubBlkH=4

Otherwise, when the width of the prediction unit is other than a multiple of 8 (when nPSW % 8 is true), the disparity sample array deriver 30941 sets the width nSubSubBlkW of the sub-sub-block to 4 and the height nSubSubBlkH of the sub-sub-block to 8 like the following expressions.

nSubSubBlkW=4

nSubSubBlkH=8

Otherwise, when the height and the width of the prediction unit are multiples of 8, provided that refDepPelsP0 is the pixel value of the depth image at the coordinates in the upper-left corner of the sub-block, refDepPelsP1 is the pixel value in the upper-right corner, refDepPelsP2 is the pixel value in the lower-left corner, and refDepPelsP3 is the pixel value in the lower-right corner, the disparity sample array deriver 30941 determines whether or not the following conditional expression (horSplitFlag) holds.

horSplitFlag=(refDepPelsP0>refDepPelsP3)==(refDepPelsP1>refDepPelsP2)

Next, the disparity sample array deriver 30941 sets the width nSubSubBlkW and the height nSubSubBlkH of the sub-sub-block using the following expressions.

nSubSubBlkW=horSplitFlag?nSubBlkW:(nSubBlkW>>1)

nSubSubBlkH=horSplitFlag?(nSubBlkH>>1):nSubBlkH

In other words, when the conditional expression (horSplitFlag) holds, the width nSubSubBlkW of the sub-sub-block is set to the width nSubBlkW of the sub-block, and the height nSubSubBlkH of the sub-sub-block is set to half the height nSubBlkH of the sub-block. If the conditional expression (horSplitFlag) does not hold, the width nSubSubBlkW of the sub-sub-block is set to half the width nSubBlkW of the sub-block, and the height nSubSubBlkH of the sub-sub-block is set to the height nSubBlkH of the sub-block.

Since the width and the height of the sub-block are 8, the sub-sub-block becomes 4×8 or 8×4.

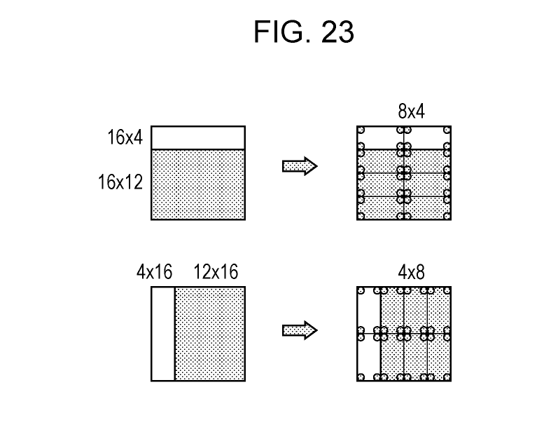

FIG. 23 is a diagram illustrating a process by the view synthesis predictor 3094B according to the present embodiment in the case in which the size of the coding unit (CU) including the prediction block is 16. In the case of AMP, when the prediction block is 16×4 or 16×12, the height of the prediction block is not a multiple of 8, and thus the prediction block is partitioned into 8×4 sub-sub-blocks, and a depth-derived disparity vector is derived for each of these sub-sub-blocks. When the prediction block is 4×16 or 12×16, the width of the prediction block is not a multiple of 8, and thus the prediction block is partitioned into 4×8 sub-sub-blocks, and a depth-derived disparity vector is derived for each of these sub-sub-blocks.

FIG. 19 is a diagram illustrating a process by the view synthesis predictor 3094B according to the present embodiment in the case in which the size of the coding unit (CU) including the prediction block is greater than 16. With the configuration of the view synthesis predictor 3094B according to the present embodiment, processing in blocks of 4×4 likewise is not produced, unlike the comparative example in FIG. 12, and thus an advantage of reducing the amount of processing is likewise exhibited.

With the above configuration, when the height of the prediction block is other than a multiple of 8, the view synthesis predictor partitions the prediction block into 8×4 sub-blocks, whereas when the width of the prediction block is other than a multiple of 8, the view synthesis predictor partitions the prediction block into 4×8 sub-blocks.

(Another Configuration of View Synthesis Predictor 3094)

Hereinafter, a view synthesis predictor 3094B which is another configuration of the view synthesis predictor will be described as a fourth embodiment of the present invention.

In the case of AMP (for example, the case in which nPSW>2×min(nPSH, nPSW-nPSH)), if the width of the prediction block is longer than the height (nPSW>nPSH), the disparity sample array deriver 30941 sets the width nSubSubBlkW of the sub-sub-block to 8 and the height nSubSubBlkH of the sub-sub-block to 4 like the following expressions.

nSubSubBlkW=8

nSubSubBlkH=4

Otherwise, in the case of AMP (for example, the case in which nPSH>2×min(nPSW, nPSH-nPSW)), if the height of the prediction block is longer than the width (nPSH>nPSW), the disparity sample array deriver 30941 sets the width nSubSubBlkW of the sub-sub-block to 4 and the height nSubSubBlkH of the sub-sub-block to 8 like the following expressions.

sets the width nSubSubBlkW of the sub-sub-block to 4 and the height nSubSubBlkH of the sub-sub-block to 8 like the following expressions.

nSubSubBlkW=4

nSubSubBlkH=8

FIG. 23 is a diagram illustrating a process by the view synthesis predictor 3094B′ according to the present embodiment in the case in which the size of the coding unit (CU) including the prediction block is 16. When the prediction block is 16×4 or 16×12 and AMP is used, the width of the prediction block is greater than the height, and thus the prediction block is partitioned into 8×4 sub-sub-blocks, and a depth-derived disparity vector is derived for each of these sub-sub-blocks. When the prediction block is 4×16 or 12×16 and AMP is used, the height of the prediction block is greater than the width, and thus the prediction block is partitioned into 4×8 sub-sub-blocks, and a depth-derived disparity vector is derived for each of these sub-sub-blocks. This process is similar to the case of the view synthesis predictor 3094B.

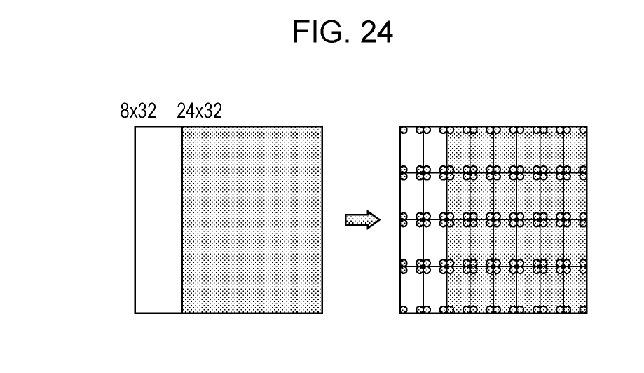

FIG. 24 is a diagram illustrating a process by the view synthesis predictor 3094B′ according to the present embodiment in the case in which the size of the coding unit (CU) including the prediction block is greater than 16. In the view synthesis predictor 3094B′, in the case of AMP, the prediction block is statically partitioned according to the size of the prediction unit, even when the size of the coding unit (CU) is greater than 16. In the drawing, when the prediction block is 8×32 or 24×32 and AMP is used, the height of the prediction block is greater than the width, and thus the prediction block is partitioned into 4×8 sub-sub-blocks, and a depth-derived disparity vector is derived for each of these sub-sub-blocks.

In the view synthesis predictor 30945′, in the case of AMP, the prediction block is partitioned into sub-sub-blocks according to the size of the prediction block. Specifically, when the prediction block is an AMP block and the width of the prediction block is longer than the height, the view synthesis predictor partitions the prediction block into 8×4 sub-blocks, whereas when the prediction block is an AMP block and the height of the prediction block is longer than the width, the view synthesis predictor partitions the prediction block into 4×8 sub-blocks. For this reason, the boundary of the sub-sub-block does not cross the boundary of the prediction unit, and thus 4×4 blocks are not produced. In the view synthesis predictor 3094B′ according to the present embodiment, processing in blocks of 4×4 is not produced, unlike the comparative example in FIG. 12, and thus an advantage of reducing the amount of processing is exhibited.

(Configuration of Image Coding Device)

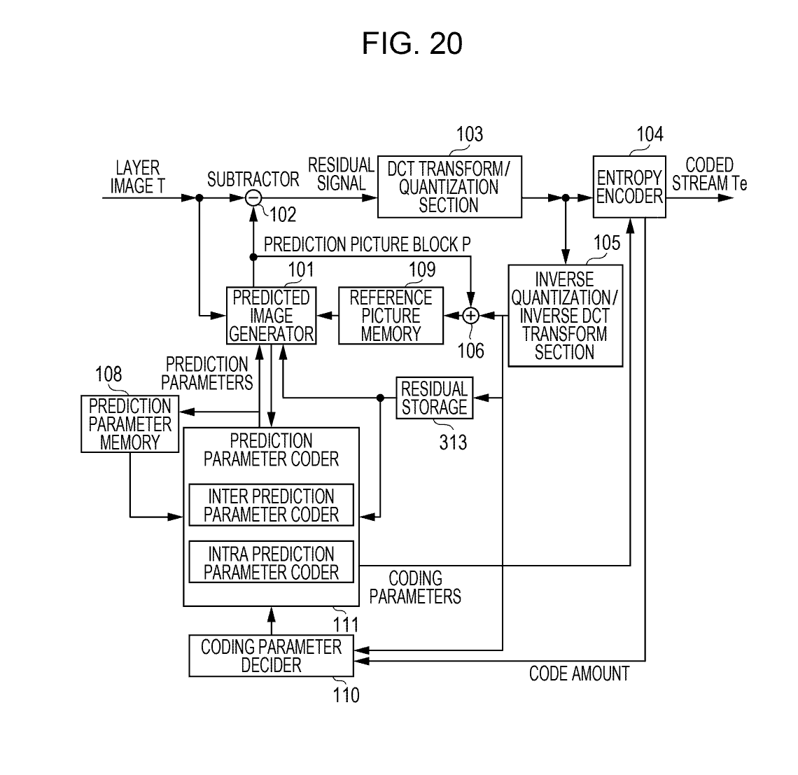

Next, a configuration of the image coding device 11 according to the present embodiment will be described. FIG. 20 is a block diagram illustrating a configuration of the image coding device 11 according to the present embodiment. The image coding device 11 is configured to include a predicted image generator 101, a subtractor 102, a DCT/quantization section 103, an entropy coder 104, an inverse quantization/inverse DCT section 105, an adder 106, prediction parameter memory (prediction parameter storage, frame memory) 108, reference picture memory (reference image storage, frame memory) 109, a coding parameter decider 110, a prediction parameter coder 111, and residual storage 313 (residual recording section). The prediction parameter coder 111 is configured to include an inter prediction parameter coder 112 and an intra prediction parameter coder 113.

The predicted image generator 101 generates a predicted picture block predSmaples for each block, which is a region obtained by partitioning each picture per view of an externally input layer image T. Herein, the predicted image generator 101 reads out a reference picture block from the reference picture memory 109 on the basis of prediction parameters input from the prediction parameter coder 111. The prediction parameters input from the prediction parameter coder 111 are a motion vector or a disparity vector, for example. The predicted image generator 101 reads out the reference picture block of the block at the predicted position indicated by the motion vector or disparity vector, taking the coding target block as the point of origin. The predicted image generator 101 generates a predicted picture block predSmaples using one prediction scheme from among multiple prediction schemes for the read-out reference picture block. The predicted image generator 101 outputs the generated predicted picture block predSmaples to the subtractor 102 and the adder 106. Note that since the predicted image generator 101 has the same operation as the predicted image generator 308 already described, a detailed description of the generation of the predicted picture block predSmaples will be omitted.

In order to select a prediction scheme, the predicted image generator 101 selects the prediction scheme that minimizes an error value based on the difference between the signal value of a pixel in a block included in the layer image and the signal value for each corresponding pixel in the predicted picture block predSmaples, for example. Note that the method of selecting a prediction scheme is not limited to the above.

When the coding target picture is a picture in the base view, the multiple prediction schemes are intra prediction, motion prediction, and merge mode. Motion prediction refers to the type of inter prediction discussed earlier that predicts across display times. Merge mode refers to prediction using the same reference picture block and prediction parameters as an already-coded block within a predetermined range from the coding target block. When the coding target picture is a picture in other than the base view, the multiple prediction schemes are intra prediction, motion prediction, merge mode (including view synthesis prediction), and disparity prediction. Disparity prediction (parallax prediction) refers to the type of inter prediction discussed earlier that predicts across different layer images (different view images). With regard to disparity prediction (parallax prediction), additional prediction (residual prediction and illumination compensation prediction) is conducted in some cases of prediction and not conducted in other cases of prediction.

When intra prediction is selected, the predicted image generator 101 outputs the prediction mode predMode indicating the intra prediction mode used when generating the predicted picture block predSmaples to the prediction parameter coder 111.

When motion prediction is selected, the predicted image generator 101 stores the motion vector mvLX used when generating the predicted picture block predSmaples in the prediction parameter memory 108, and outputs to the inter prediction parameter coder 112. The motion vector mvLX indicates the vector from the position of the coding target block to the position of the reference picture block when generating the predicted picture block predSmaples. The information indicating the motion vector mvLX includes information indicating the reference picture (for example, the reference picture index refldxLX and the picture order count POC), and may also express prediction parameters. In addition, the predicted image generator 101 outputs the prediction mode predMode indicating the inter prediction mode to the prediction parameter coder 111.

When disparity prediction is selected, the predicted image generator 101 stores the disparity vector used when generating the predicted picture block predSmaples in the prediction parameter memory 108, and outputs to the inter prediction parameter coder 112. The disparity vector dvLX indicates the vector from the position of the coding target block to the position of the reference picture block when generating the predicted picture block predSmaples. The information indicating the disparity vector dvLX includes information indicating the reference picture (for example, the reference picture index refIdxLX and the view ID view_Id), and may also express prediction parameters. In addition, the predicted image generator 101 outputs the prediction mode predMode indicating the inter prediction mode to the prediction parameter coder 111.

When merge mode is selected, the predicted image generator 101 outputs the merge index merge_idx indicating the selected reference picture block to the inter prediction parameter coder 112. In addition, the predicted image generator 101 outputs the prediction mode predMode indicating the merge mode to the prediction parameter coder 111.

In the above merge mode, when the VSP mode flag VspModeFlag indicates that view synthesis prediction is to be conducted, the predicted image generator 101 conducts view synthesis prediction in the view synthesis predictor 3094 included in the predicted image generator 101 as already described. Also, in motion prediction, disparity prediction, and merge mode, when the residual prediction execution flag resPredFlag indicates that residual prediction is to be conducted, the predicted image generator 101 conducts residual prediction in the residual predictor 3092 included in the predicted image generator 101 as already described.

The subtractor 102 generates a residual signal by subtracting, for each pixel, the signal value of the predicted picture block predSmaples input from the predicted image generator 101 from the signal value of the corresponding block in the externally input layer image T. The subtractor 102 outputs the generated residual signal to the DCT/quantization section 103 and the coding parameter decider 110.

The DCT/quantization section 103 performs the DCT on the residual signal input from the subtractor 102, and computes DCT coefficients. The DCT/quantization section 103 quantizes the computed DCT coefficients to compute quantized coefficients. The DCT/quantization section 103 outputs the computed quantized coefficients to the entropy coder 104 and the inverse quantization/inverse DCT section 105.

Quantized coefficients from the DCT/quantization section 103 and coding parameters from the coding parameter decider 110 are input into the entropy coder 104. The input coding parameters include codes such as the reference picture index refIdxLX, the vector index mvp_LX_idx, the difference vector mvdLX, the prediction mode predMode, the merge index merge_idx, the residual prediction weight index iv_res_pred_weight_idx, and the illumination compensation flag ic_flag, for example.

The entropy coder 104 performs entropy coding on the input quantized coefficients and coding parameters to generate the coded stream Te, and externally outputs the generated coded stream Te.

The inverse quantization/inverse DCT section 105 computes DCT coefficients by inversely quantizing the quantized coefficients input from the DCT/quantization section 103. The inverse quantization/inverse DCT section 105 performs the inverse DCT on the computed DCT coefficients to compute a decoded residual signal. The inverse quantization/inverse DCT section 105 outputs the computed decoded residual signal to the adder 106, the residual storage 313, and the coding parameter decider 110.

The adder 106 generates reference picture blocks by adding together, for each pixel, the signal values of the predicted picture blocks predSmaples input from the predicted image generator 101 and the signal values of the decoded residual signal input from the inverse quantization/inverse DCT section 105. The adder 106 stores the generated predicted picture blocks in the reference picture memory 109.

The prediction parameter memory 108 stores prediction parameters generated by the prediction parameter coder 111 at a predetermined position for each coding target picture and block.

The reference picture memory 109 stores the reference picture blocks generated by the adder 106 at a predetermined position for each coding target picture and block.

The coding parameter decider 110 selects one set from among the multiple sets of coding parameters. The coding parameters refer to the prediction parameters and the parameters to be coded which are generated in relation to the prediction parameters. The predicted image generator 101 generates the predicted picture blocks predSmaples using each of these sets of coding parameters.

The coding parameter decider 110 computes a cost value indicating the quantity of information and coding error for each of the multiple sets. The cost value is the sum of the code amount and the value obtained by multiplying the square of the error by a coefficient λ, for example. The code amount is the information amount in the coded stream Te obtained by performing entropy coding on the quantized error and the prediction parameters. The square of the error is the sum over all pixels of the squares of the residual values of the residual signal computed in the subtractor 102. The coefficient λ is a preset real number greater than zero. The coding parameter decider 110 selects the set of coding parameters for which the computed cost value is minimized. Consequently, the entropy coder 104 externally outputs the selected coding parameter set as the coded stream Te, and does not output the coding parameter sets that were not selected.

The prediction parameter coder 111 derives prediction parameters to use when generating a predicted picture on the basis of the parameters input from the predicted image generator 101, and codes the derived prediction parameters to generate a set of coding parameters. The prediction parameter coder 111 outputs the generated set of coding parameters to the entropy coder 104.

The prediction parameter coder 111 stores, in the prediction parameter memory 108, the prediction parameters corresponding to those selected by the coding parameter decider 110 from among the generated sets of coding parameters.

The prediction parameter coder 111 causes the inter prediction parameter coder 112 to operate when the prediction mode predMode input from the predicted image generator 101 indicates an inter prediction mode. The prediction parameter coder 111 causes the intra prediction parameter coder 113 to operate when the prediction mode predMode indicates an intra prediction mode.

The inter prediction parameter coder 112 derives inter prediction parameters on the basis of the prediction parameters input from the coding parameter decider 110. The configuration of the inter prediction parameter coder 112 that derives the inter prediction parameters is the same as the configuration of the inter prediction parameter decoder 303 (see FIG. 5 and the like) that derives inter prediction parameters. The configuration of the inter prediction parameter coder 112 will be discussed later.

The intra prediction parameter coder 113 decides the intra prediction mode IntraPredMode indicated by the prediction mode predMode input from the coding parameter decider 110 as a set of inter prediction parameters.

(Configuration of Inter Prediction Parameter Coder)

Next, a configuration of the inter prediction parameter coder 112 will be described. The inter prediction parameter coder 112 is a means corresponding to the inter prediction parameter decoder 303.

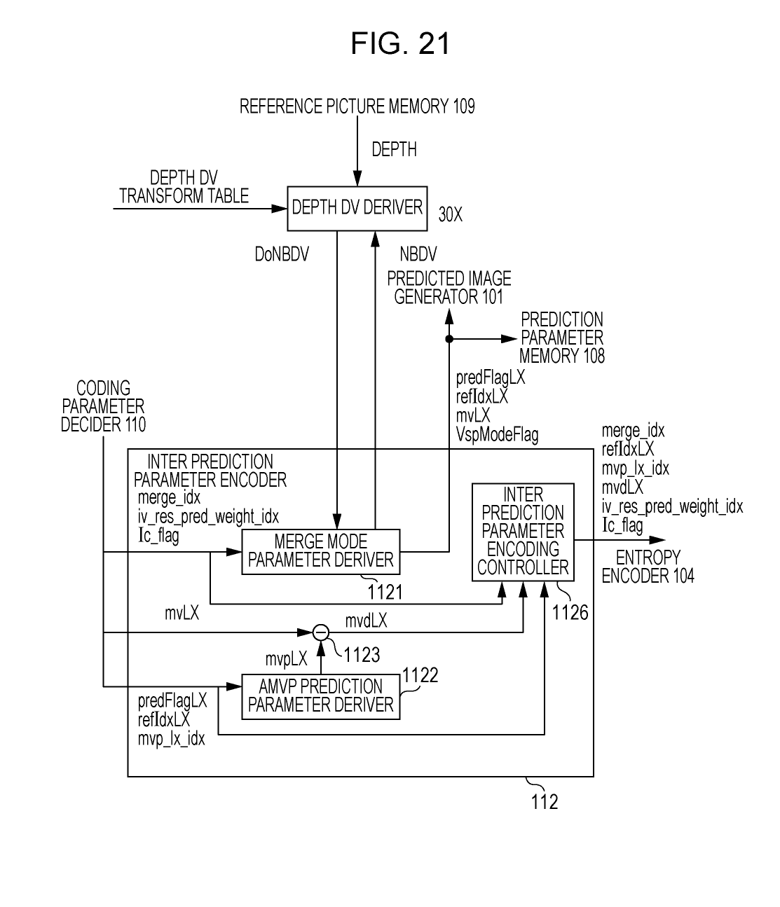

FIG. 21 is a schematic diagram illustrating a configuration of the inter prediction parameter coder 112 according to the present embodiment.

The inter prediction parameter coder 112 is configured to include a merge mode parameter deriver 1121, an AMVP prediction parameter deriver 1122, a subtractor 1123, and an inter prediction parameter coding controller 1126.

The merge mode parameter deriver 1121 has a similar configuration to the merge mode parameter deriver 3036 discussed earlier (see FIG. 7).

The AMVP prediction parameter deriver 1122 has a similar configuration to the AMVP prediction parameter deriver 3032 discussed earlier (see FIG. 7).

The subtractor 1123 generates the difference vector mvdLX by subtracting the prediction vector mvpLX input from the AMVP prediction parameter deriver 1122 from the vector mvLX input from the coding parameter decider 110. The difference vector mvdLX outputs to the inter prediction parameter coding controller 1126.

The inter prediction parameter coding controller 1126 encodes codes (syntax elements) included in the coded data that instruct the entropy coder 104 to decode codes (syntax elements related to inter prediction, such as the partition mode part_mode, the merge_flag merge_flag, the merge index merge_idx, the inter prediction flag inter_pred_idc, the reference picture index refldxLX, the prediction vector index mvp_LX_idx, and the difference vector mvdLX,

The inter prediction parameter coding controller 1126 is configured to include an additional prediction flag coder 10311, a merge index coder 10312, and a vector candidate index coder 10313, as well as a partition mode coder, a merge_flag coder, an inter prediction flag coder, a reference picture index coder, and a vector difference coder. The partition mode coder, the merge_flag coder, the merge index coder, the inter prediction flag coder, the reference picture index coder, the vector candidate index coder 10313, and the vector difference coder code the partition mode part_mode, the merge_flag merge_flag, the merge index merge_idx, the inter prediction flag inter_pred_idc, the reference picture index refIdxLX, the prediction vector index mvp_LX_idx, and the difference vector mvdLX, respectively.

The additional prediction flag coder 10311 codes the illumination compensation flag ic_flag and the residual prediction weight index iv_res_pred_weight_idx to indicate whether or not additional prediction is to be conducted.

When the prediction mode predMode input from the predicted image generator 101 indicates a merge mode, the inter prediction parameter coding controller 1126 outputs to and causes the entropy coder 104 to code the merge index merge_idx input from the coding parameter decider 110.

Also, the inter prediction parameter coding controller 1126 conducts the following process when the prediction mode predMode input from the predicted image generator 101 indicates an inter prediction mode.

The inter prediction parameter coding controller 1126 combines the reference picture index refIdxLX and the vector index mvp_LX_idx input from the coding parameter decider 110 with the difference vector mvdLX input from the subtractor 1123. The inter prediction parameter coding controller 1126 outputs to and causes the entropy coder 104 to code the combined code. The above image coding device is equipped with the view synthesis predictor 3094 as the view synthesis predictor. When the height of the prediction block is other than a multiple of 8, the view synthesis predictor 3094 partitions the prediction block into 8×4 sub-sub-blocks, whereas when the width of the prediction block is other than a multiple of 8, the view synthesis predictor 3094 partitions the prediction block into 4×8 sub-sub-blocks. With the view synthesis predictor 3094, the boundary of the sub-sub-block does not cross the boundary of the prediction unit, and thus 4×4 blocks are not produced. In the view synthesis predictor 3094 according to the present embodiment, processing in blocks of 4×4 is not produced, unlike the comparative example in FIG. 12, and thus an advantage of reducing the amount of processing is exhibited.

(Another Configuration of Image Coding Device)

In another configuration of the image coding device, the view synthesis predictor 3094′ is provided as the view synthesis predictor. As already described, with the view synthesis predictor 3094′, the boundary of the sub-sub-block does not cross the boundary of the prediction unit, and thus 4×4 blocks are not produced. In the view synthesis predictor 3094 according to the present embodiment, processing in blocks of 4×4 is not produced, unlike the comparative example in FIG. 12, and thus an advantage of reducing the amount of processing is exhibited.

(Another Configuration of Image Coding Device)

In another configuration of the image coding device, the view synthesis predictor 3094B is provided as the view synthesis predictor. As already described, with the view synthesis predictor 3094B, the boundary of the sub-sub-block does not cross the boundary of the prediction unit, and thus 4×4 blocks are not produced. In the view synthesis predictor 3094 according to the present embodiment, processing in blocks of 4×4 is not produced, unlike the comparative example in FIG. 12, and thus an advantage of reducing the amount of processing is exhibited.

(Another Configuration of Image Coding Device)

In another configuration of the image coding device, the view synthesis predictor 3094B′ is provided as the view synthesis predictor. As already described, with the view synthesis predictor 3094B′, the boundary of the sub-sub-block does not cross the boundary of the prediction unit, and thus 4×4 blocks are not produced. In the view synthesis predictor 3094 according to the present embodiment, processing in blocks of 4×4 is not produced, unlike the comparative example in FIG. 12, and thus an advantage of reducing the amount of processing is exhibited.

Note that part of the image coding device 11 and the image decoding device 31 in the foregoing embodiments, such as the entropy decoder 301, the prediction parameter decoder 302, the predicted image generator 101, the DCT/quantization section 103, the entropy coder 104, the inverse quantization/inverse DCT section 105, the coding parameter decider 110, the prediction parameter coder 111, the entropy decoder 301, the prediction parameter decoder 302, the predicted image generator 308, and the inverse quantization/inverse DCT section 311, for example, may also be realized with a computer. In this case, a program for realizing the control functions may be recorded to a computer-readable recording medium, with the communication apparatus being realized by causing a computer system to read and execute the program recorded on the recording medium. Note that the “computer system” referred to herein is a computer system built into any either of the image coding device 11 and the image decoding device 31, and is assumed to include an OS and hardware such as peripheral devices. In addition, the “computer-readable recording medium” refers to a portable medium such as a flexible disk, a magneto-optical disc, ROM, or a CD-ROM, or a storage device such as a hard disk built into the computer system. Furthermore, the term “computer-readable recording medium” may also encompass media that briefly or dynamically retain the program, such as a communication line in the case of transmitting the program via a network such as the Internet or a communication channel such as a telephone line, as well as media that retain the program for a given period of time, such as volatile memory inside the computer system acting as the server or client in the above case. Moreover, the above program may be for realizing part of the functions discussed earlier, and may also realize the functions discussed earlier in combination with programs already recorded to the computer system.

In addition, all or part of the image coding device 11 and the image decoding device 31 in the foregoing embodiments may also be realized as an integrated circuit realized by a process such as large-scale integration (LSI). The respective function blocks of the image coding device 11 and the image decoding device 31 may be realized as individual processors, or all or part thereof may be integrated as a single processor. Furthermore, the circuit integration methodology is not limited to embedded applications and may be also be realized with special-purpose circuits, or with general-purpose processors. In addition, if progress in semiconductor technology yields integrated circuit technology that may substitute for LSI, an integrated circuit according to that technology may also be used.

The foregoing thus describes embodiments of the present invention in detail and with reference to the drawings. However, specific configurations are not limited to the foregoing, and various design modifications and the like are possible within a scope that does not depart from the principal matter of the present invention.

The present invention is not limited to the embodiments discussed above, and various modifications are possible within the scope indicated by the claims. Embodiments obtained by appropriately combining the technical means respectively disclosed in different embodiments are also included within the technical scope of the present invention. Furthermore, new technical features may be formed by combining the technical means respectively disclosed in each of the embodiments.

[Supplementary Notes]

(1) The present invention was devised to address the issue discussed above, and one aspect of the present invention is an image decoding device that generates and decodes a predicted image of a target prediction block, including a view synthesis predictor that generates a predicted image using view synthesis prediction. The view synthesis predictor partitions the prediction block into sub-blocks according to whether or not the height or the width of the prediction block is other than a multiple of 8, and the view synthesis predictor derives a depth-derived disparity for each of the sub-blocks.

(2) Additionally, another aspect of the present invention is the image decoding device according to (1), wherein, in a case of the height or the width of the prediction block being other than a multiple of 8, the view synthesis predictor does not partition the prediction block and instead treats the prediction block as the sub-block, whereas in a case of the height and the width of the prediction block being multiples of 8, the view synthesis predictor partitions the prediction block into sub-blocks less than the prediction block.

(3) Additionally, another aspect of the present invention is the image decoding device according to (1), wherein in a case of the height of the prediction block being other than a multiple of 8, the view synthesis predictor partitions the prediction block into 8×4 sub-blocks, whereas in a case of the width of the prediction block being other than a multiple of 8, the view synthesis predictor partitions the prediction block into 4×8 sub-blocks.

(4) Additionally, another aspect of the present invention is the image decoding device according to (1), wherein the view synthesis predictor partitions the prediction block into sub-blocks according to whether or not the prediction block is an AMP block.

(5) Additionally, another aspect of the present invention is the image decoding device according to (4), wherein in a case of the prediction block being an AMP block and the width of the prediction block being longer than the height, the view synthesis predictor partitions the prediction block into 8×4 sub-blocks, whereas in a case of the prediction block being an AMP block and the height of the prediction block being longer than the width, the view synthesis predictor partitions the prediction block into 4×8 sub-blocks.

(6) Additionally, another aspect of the present invention is the image decoding device according to (1) to (5), wherein in a case of the height and the width of the prediction block being multiples of 8, the view synthesis predictor partitions the prediction block into 8×4 or 4×8 sub-blocks.

(7) Additionally, another aspect of the present invention is an image coding device that generates and decodes a predicted image of a target prediction block, including a view synthesis predictor that generates a predicted image using view synthesis prediction. The view synthesis predictor partitions the prediction block into sub-blocks according to whether or not the height or the width of the prediction block is other than a multiple of 8, and the view synthesis predictor derives a depth-derived disparity for each of the sub-blocks.

### INDUSTRIAL APPLICABILITY

The present invention may be suitably applied to an image decoding device that decodes coded data into which image data is coded, and an image coding device that generates coded data into which image data is coded. The present invention may also be suitably applied to a data structure of coded data that is generated by an image coding device and referenced by an image decoding device.

### REFERENCE SIGNS LIST

1 image transmission system
11 image coding device
101 predicted image generator
102 subtractor
103 DCT/quantization section
10311 additional prediction flag coder
10312 merge index coder
10313 vector candidate index coder
104 entropy coder
105 inverse quantization/inverse DCT section
106 adder
108 prediction parameter memory (frame memory)
109 reference picture memory (frame memory)
110 coding parameter decider
111 prediction parameter coder
112 inter prediction parameter coder
1121 merge mode parameter deriver
1122 AMVP prediction parameter deriver
1123 subtractor
1126 inter prediction parameter coding controller
113 intra prediction parameter coder
21 network
31 image decoding device
301 entropy decoder
302 prediction parameter decoder
303 inter prediction parameter decoder
3031 inter prediction parameter decoding controller
30311 residual prediction index decoder
303111 reference layer determiner
30312 merge index decoder
30313 vector candidate index decoder
3032 AMVP prediction parameter deriver
3035 adder
3036 merge mode parameter deriver
30361 merge candidate deriver
303611 merge candidate storage
303612 enhancement merge candidate deriver
3036121 inter-layer merge candidate deriver
3036122 disparity vector acquirer
3036123 disparity merge candidate deriver
303613 base merge candidate deriver
3036131 spatial merge candidate deriver
3036132 temporal merge candidate deriver
3036133 combined merge candidate deriver
3036134 zero merge candidate deriver
30362 merge candidate selector
304 intra prediction parameter decoder
306 reference picture memory (frame memory)
307 prediction parameter memory (frame memory)
308 predicted image generator
309 inter-predicted image generator
3091 motion/disparity compensator
3092 residual predictor
30921 residual prediction execution flag deriver
30922 reference image acquirer
30923 residual synthesis section
3093 illumination compensator
3094 view synthesis predictor
310 intra-predicted image generator
311 inverse quantization/inverse DCT section
312 adder
313 residual storage
41 image display device

1. An image decoding device that generates and decodes a predicted image of a prediction block, comprising:
a view synthesis predictor that generates a disparity to use in view synthesis prediction, wherein
the view synthesis predictor sets a sub-block size according to whether or not the height or the width of the prediction block is a multiple of 8, and uses the sub-block size to reference depth and derive a depth-derived disparity.

2. The image decoding device according to claim 1, wherein
in a case of the height of the prediction block being other than a multiple of 8, the view synthesis predictor sets the sub-block size to 8×4, whereas in a case of the width of the prediction block being other than a multiple of 8, the view synthesis predictor sets the sub-block size to 4×8.

3. The image decoding device according to claim 1, wherein
in a case of the height and the width of the prediction block being multiples of 8, the view synthesis predictor sets the sub-block size to 8×4 or 4×8 according to depth pixels at an upper-left corner, an upper-right corner, a lower-left corner, and a lower-right corner.

4. An image coding device that generates and decodes a predicted image of a prediction block, comprising:
a view synthesis predictor that generates a disparity to use in view synthesis prediction, wherein
the view synthesis predictor sets a sub-block size according to whether or not the height or the width of the prediction block is a multiple of 8, and uses the sub-block size to reference depth and derive a depth-derived disparity.
